(19) United States
(12) Patent Application Publication
(10) Pub. No.: US 2005/0050402 A1
(43) Pub. Date: Mar. 3, 2005

(54) Information recording medium, recording apparatus and method, reproducing apparatus and method, computer program for controlling record or reproduction, and data structure including control signal

(76) Inventors: Takeshi Koda, Saitama (JP); Masayoshi Yoshida, Saitama (JP); Keiji Katata, Saitama (JP)

Correspondence Address: YOUNG & THOMPSON, 745 SOUTH 23RD STREET, 2ND FLOOR, ARLINGTON, VA, 22202, US

(21) Appl. No.: 10/916,453

(22) Filed: Aug. 12, 2004

(30) Foreign Application Priority Data
Aug. 12, 2003 (JP) 2003-207286

(51) Int. Cl. G06F 11/00

(52) U.S. Cl. 714/42

(57) ABSTRACT

An information recording medium provided with: a data area for recording therein record data; and a temporary defect management area for temporarily recording therein defect management information which is a basis of defect management for a defect in the data area, the defect management information being divided into a plurality of divisional defect management information in which one divisional defect management information can be updated independently of another divisional defect management information and being recorded, if the defect management information exceeds a predetermined size.

### BACKGROUND OF THE INVENTION

1. Field of the Invention

The present invention relates to an information recording medium, a recording apparatus for and a recording method of recording the record data onto the information recording medium, a reproducing apparatus for and a reproducing method of reproducing the record data recorded on the information recording medium, a computer program for controlling record or reproduction, and a data structure including a control signal for controlling record or reproduction.

2. Description of the Related Art

As a technique of improving the reliability of the recording and reading of the record data on a high-density recording medium, such as an optical disc, a magnetic disc, and a magneto optical disc, there is defect management. Namely, when there are scratches or dusts, or deterioration (which are collectively referred to as a “defect”) on the recording medium, the data to be recorded or already recorded at the position of the defect is recorded into another area on the recording medium (which is referred to as a “spare area”). In this manner, by evacuating the record data, which is possibly imperfectly or incompletely recorded or read or reproduced because of the defect, to the spare area, it is possible to improve the reliability of the recording and reading/reproducing of the record data (refer to Japanese Patent Application Laying Open NO. Hei 11-185390).

In general, a defect list is made to perform the defect management. On the defect list, there are recorded address information for indicating the position of a defect on the recording medium, and address information for indicating the position of the spare area to which the data to be recorded or already recorded at the position of the defect is evacuated.

The defect list is made when an initial logical format for initializing the recording medium or recording file-system data or the like onto the recording medium is performed. The defect list is also made when the record data is recorded onto the recording medium. When the record data is recorded and rewritten several times, the defect list is made or updated whenever the record data is recorded and rewritten and a defect area is detected, or whenever the record data is evacuated to the spare area. Moreover, the defect list may be made when the record data is reproduced from the recording medium. For example, if a predetermined number or more of data is error-corrected with respect to a predetermined unit (e.g. a sector unit or and a cluster unit) of the record data when the record data is reproduced, the predetermined unit of the record data is judged or determined to be a defect which cannot be error-corrected in the future and will be an object of the evacuation. As described above, the defect list is made or updated whenever the record data is evacuated to the spare area.

When the record data is recorded onto the recording medium, the defect list is referred to. This allows the recording of the record data onto the recording medium away from the position of a defect. On the other hand, the defect list is also referred to when the record data recorded on the recording medium is reproduced or read. This makes it possible to surely read both the record data recorded in a normal recording area and the record data recorded in the spare area because of the presence of a defect, on the basis of the defect list.

If the defect list is managed by a recording apparatus itself for recording the data, the defect list is generally recorded into a specific area on the recording medium, which is the object of the making or updating of the defect list. The defect list is read from the recording medium when the record data recorded on the recording medium is reproduced or when other record data is rewritten or additionally recorded (i.e. written once). Then the defect list is referred to in a reading operation by a reading apparatus or in a reproduction operation by a reproducing apparatus.

### SUMMARY OF THE INVENTION

If the defect list is managed by the recording apparatus, the defect list is recorded into the specific area on the recording medium. For example, in the case of a rewritable-type optical disc using a blue laser, the defect list is recorded into a predetermined area (which is hereinafter referred to as a “defect management area”) reserved in a lead-in area or lead-out area on the disc. The record data to be originally recorded at the position of a defect is also recorded into the specific area on the recording medium.

As described above, the defect list is updated whenever the record data is recorded and rewritten and the defect area is found at the position, or whenever the record data is evacuated to the spare area. Then, the defect list is overwritten or additionally recorded (i.e. written once) in the defect management area on the recording medium which is the object of the recording and rewriting, at an appropriate timing after the defect list is updated by the recording and rewriting of record data. In addition, the record data to be originally recorded at the position of a defect is also overwritten or additionally recorded (i.e. written once) into the specific area on the recording medium.

Such updating of the defect list by rewriting it can be realized only in case that the recording medium is rewritable-type. In case that the recording medium is a so-called “write-once-type information recording medium”, e.g., a write-once-type optical disc, after the defect list is updated, the updated defect list is additionally recorded (i.e. written once) in a new unrecorded or blank area of the information recording medium at an appropriate timing, for example.

Here, a new area for recording therein the defect list is managed by a cluster unit having a predetermined size on the standard of the information recording medium. The defect list is recorded and written once by the cluster unit. If the size of the defect list is larger than that of one cluster unit, the defect list is recorded onto the information recording medium by using two or more cluster units. Then, if another defect is further generated, new defect management information (defect list) having the size of the two or more cluster units is additionally recorded by using other two or more cluster units again.

Therefore, there is a technical problem that as the number of the additional or sequential or postscript recording increases, the recording area required for recording the defect management information increases. This shortens a time length in which the defect management can be performed on the write-once type information recording medium onto which the record data can be recorded only once at the one recording position, and consequently shortens the life time of the disc.

It is therefore an object of the present invention to provide: an information recording medium which efficiently uses the recording capacity of the recording medium and on which the defect management can be performed; a recording apparatus for and a recording method of recording the record data onto the information recording medium; a reproducing apparatus for and a reproducing method of reproducing the record data recorded on the information recording medium; a computer program used for the recording apparatus or the reproducing apparatus; and a data structure including a control signal for controlling record or reproduction.

(Information Recording Medium)

The above object of the present invention can be achieved by an information recording medium provided with: a data area for recording therein record data; and a temporary defect management area for temporarily recording therein defect management information which is a basis of defect management for a defect in the data area, the defect management information being divided into a plurality of divisional defect management information in which one divisional defect management information can be updated independently of another divisional defect management information and being recorded, if the defect management information exceeds a predetermined size.

According to the information recording medium of the present invention, the record data which is mainly the object of reproduction or execution and which includes, e.g., image data (or video data); audio data; text data; contents data; a computer program; or the like can be recorded into the data area. Then, it is possible to appropriately record and reproduce the record data recorded in the data area by recording, into a control information recording area described later, for example, control information which includes: information for indicating the attribute and type of the information recording medium of the present invention; information for managing the address of the record data; information for controlling the recording and reading/reproducing operations of a recording/reproducing apparatus; or the like. Incidentally, the record data and the control information cannot be always clearly classified in accordance with the content thereof. However, the control information is mainly used directly for the operation control of the recording/reproducing apparatus, while the record data is mainly only the object of recording and reading and is mainly used in a reproduction operation or in a program execution operation by a backend or a host computer of the recording/reproducing apparatus or the like.

The defect management information is temporarily recorded into the temporary defect management area. The “defect management information” in the present invention is information used for the defect management, and includes: an evacuation source address, which is an address of the position of a defect in the data area; and an evacuation destination address, which is an address of the recording position of evacuation data that is the record data to be originally recorded or already recorded at the position of the defect. The defect management is as follows. When there is a defect, such as scratches, dusts, or deterioration, in or on the information recording medium of the present invention, the record data is recorded into a position away from the position of the defect. At the same time, the evacuation data is recorded into the spare area which is an area for recording therein the record data away from the defect. Moreover, the following processing is also performed as a part of the defect management: recognizing processing which recognizes the position of a defect when the record data recorded on the information recording medium is reproduced; and reading processing which reads the evacuation data from the spare area.

For example, the temporary defect management area is an area for temporarily recording therein the defect management information until the information recording medium of the present invention is finalized. Therefore, in reproducing the record data recorded on the information recording medium until it is finalized, the defect management is performed by reading the defect management information from the temporary defect management area. Incidentally, one temporary defect management area may be provided on the information recording medium. Alternatively, two, three or more temporary defect management areas may be provided.

Particularly, in the present invention, the defect management information is recorded as the plurality of divisional defect management information into which the defect management information is divided. Such division of the defect management information is performed if the defect management information exceeds a predetermined size. When the defect management information, which is recorded as the plurality of divisional defect management information is updated and recorded (or additionally recorded or written once), by the operation of a recording apparatus described later, it is sufficient to update and record at least one of the plurality of divisional defect management information. Namely, by independently updating one of the plurality of divisional management information, it is possible to record the newest defect management information without updating another divisional defect management information.

By this, it is unnecessary to update and record the defect management information as a whole repeatedly, and if minimum updating is performed, it is possible to obtain the same effect as when the whole defect management information is updated. Therefore, as compared to the aspect of updating and recording the whole defect management information, it is possible to reduce the recording capacity required for the updating of the defect management information. In particular, it is possible to efficiently use the temporary defect management area.

In particular, with respect to the write-once type information recording medium onto which the record data can be recorded only once at each position, an area for additionally recording (or writing once) the defect management information (i.e. the temporary defect management area) is limited in space, so that a more efficient recording aspect is desired. Since the defect management information can be efficiently updated or recorded by virtue of the information recording medium of the present invention, the write-once type information recording medium has an extreme advantage. Namely, by efficiently using the temporary defect management area, it is possible to extend a time length in which the defect management is possible and it is possible to increase the lifetime as the information recording medium.

As a result, according to the information recording medium of the present invention, it is possible to update the defect management information while efficiently using the temporary defect management area by dividing the defect management information into the plurality of divisional defect management information each of which can be updated independently and by recording at least one of the plurality of divisional defect management information.

In one aspect of the information recoding medium of the present invention, the temporary defect management area is divided into a plurality of divisional management areas, each having a predetermined size, and at least one of the plurality of divisional defect management information is recorded into at least one of the plurality of divisional management areas.

According to this aspect, it is possible to record the divisional defect management information according to the divisional management area. Namely, it is possible to record, update, or additionally record (or write once) the divisional defect management information appropriately, according to one standard which may be the size of the divisional management area. The divisional management area is not only a physically divided area, but also broadly includes a logically divided area.

If the size of the defect management information is larger than that of the divisional management area (especially at least one of the plurality of divisional management areas into which the defect management information is to be recorded), the defect management information is preferably recorded in the plurality of divisional management areas as the divisional defect management information.

Incidentally, the predetermined size is preferably the smallest recording unit of the information recording medium of the present invention, such as an ECC cluster.

In another aspect of the information recoding medium of the present invention, each of the plurality of divisional defect management information includes a plurality of defect list entries, each of which includes an evacuation source address which is an address of a position of the defect and an evacuation destination address which is an address of a recording position of evacuation data that corresponds to the record data to be recorded or already recorded at the position of the defect.

According to this aspect, the divisional defect management information (or the defect management information reconstructed therefrom) is made of the plurality of defect list entries. The divisional defect management information is preferably divided by a unit of the defect list entry. By this, in updating the defect management information, it is sufficient to additionally record at least one defect list entry, for example. Namely, it is possible to update the defect management information more efficiently.

In an aspect of the information recording medium including the defect list entries as described above, each of the plurality of defect list entries is included in at least one of the plurality of divisional defect management information, with the plurality of defect list entries sorted according to a value of the evacuation source address owned by each of the plurality of defect list entries.

By constituting in this manner, even if the defect management information is recorded as the plurality of divisional defect management information, it is possible to obtain the reconstructed original defect management information relatively easily.

Incidentally, it is preferable that the plurality of defect list entries are sorted even in the whole defect management information and sorted even in the divisional defect management information in which this plurality of defect list entries are included.

Moreover, even in the case that the plurality of defect list entries are not sorted, it is possible to obtain the same effect as in the information recording medium of the present invention if a recording apparatus or a reproducing apparatus, which will be described later, has a memory or the like and manages the order or sorting of the defect list entries on the memory.

In another aspect of the information recoding medium of the present invention, pointer information for indicating a relationship among the plurality of divisional defect management information is further recorded.

According to this aspect, it is possible to arrange (or recombine) the plurality of divisional defect management information relatively easily and obtain the original defect management information by referring to the pointer information.

Incidentally, the pointer information may indicate an address value of the divisional defect management information as described later, or may indicate a relationship among the plurality of divisional defect management information in a list form. Alternatively, even other information except the above is included in the pointer information of the present invention if capable of arranging the plurality of divisional defect management information and obtaining the original defect management information.

In an aspect of the information recording medium on which the pointer information is recorded, the pointer information includes at least one of address values of the plurality of divisional defect management information, with the address values sorted according to the evacuation source address included in the at least one of the plurality of divisional defect management information.

By constituting in this manner, it is possible to reconstruct the original defect management information relatively easily by arranging the divisional defect management information in the order of the address value shown by the pointer information.

Moreover, in the case of the write-once type information recording medium, for example, it is sufficient for the pointer information to include information for indicating a relationship among the divisional defect management information which constitutes the newest (or effective) defect management information. Therefore, the pointer information does not have to include information for indicating a relationship among old divisional defect management information before updating. The pointer information may include the information for indicating a relationship among old divisional defect management information.

In an aspect of the information recording medium on which the pointer information is recorded, setting information for indicating a basic structure of the information recording medium is further recorded in the temporary defect management area, and the pointer information is recorded in the setting information.

By constituting in this manner, for example, in the operation of the recording apparatus or reproducing apparatus described later, it is possible to refer to the pointer information as well as the setting information. Therefore, it is possible to refer to or record the pointer information without adding a new reproduction or record operation.

In an aspect of the information recording medium on which the pointer information is recorded, the pointer information is recorded in header information owned by the defect management information.

By constituting in this manner, it is possible to obtain the pointer information relatively easily by referring to the header information.

Incidentally, the present invention is not limited to that the defect management information has the one common header information. Each of the plurality of divisional defect management information may have the header information. The header information owned by each of the plurality of divisional defect management information may have the pointer information therein. In this case, the pointer information may be a chain-type pointer for indicating the next-placed division defect management information.

In another aspect of the information recording medium of the present invention, the defect management information is divided into the one divisional defect management information corresponding to one portion of the data area and the another divisional defect management information corresponding to another portion of the data area except the one portion.

According to this aspect, it is possible to appropriately divide the defect management information into the plurality of divisional defect management information correspondingly to the position of a defect on the data area. For example, if the information recording medium of the present invention is a disc-shaped information recording medium, the defect management information may be divided into the one divisional defect management information corresponding to the outer circumferential side of the data area and the another divisional defect management information corresponding to the inner circumferential side of the data area

(Recording Apparatus and Method)

The above object of the present invention can be achieved by a recording apparatus for recording record data onto an information recording medium provided with: (i) a data area for recording therein the record data; and (ii) a temporary defect management area for temporarily recording therein defect management information which is a basis of defect management for a defect in the data area, the recording apparatus provided with: a first recording device for recording the record data; a second recording device for recording the defect management information; a judging device for judging whether or not the defect management information which exceeds a predetermined size is to be recorded by the second recording device; and a first control device for controlling the second recording device to divide the defect management information into a plurality of divisional defect management information in which one divisional defect management information can be updated independently of another divisional defect management information and to record the defect management information, if it is judged by the judging device that the defect management information which exceeds the predetermined size is to be recorded.

According to the recoding apparatus of the present invention, it is possible to appropriately record the record data or the like onto the above-described information recording medium of the present invention by using the first and second recording devices, which includes: an optical pickup; a controller for controlling the optical pickup; or the like, for example.

Specifically, at first, the first recording device records the record data into the data area on the information recording medium. If the defect management information is updated by detecting a defect or the like, the second recording device records the defect management information into the temporary defect management area on the information recording medium.

In (or before) the operation by the second recording device, it is judged by the judging device whether or not the size of the defect management information is larger than a predetermined size. The “predetermined size” in the present invention may be the smallest recording unit of the information recording medium or the like (e.g. the ECC cluster unit) or may be a data size determined in advance.

If it is judged that the defect management information having a larger size than the predetermined size is to be recorded, the second recording device is controlled by the first control device to divide the defect management information into the plurality of divisional defect management information in which one divisional defect management information can be updated independently of another divisional defect management information and to record the defect management information. Namely, the second recording device is controlled to record the defect management information by a unit of the above-described divisional defect management information.

Moreover, even in further updating and additionally recording the divisional defect management information, if it is judged that the size of the divisional defect management information to be recorded is larger than the predetermined unit, the first control device preferably controls the second recording device to further divide and record the divisional defect management information.

As a result, according to the recording apparatus of the present invention, it is possible to appropriately record the record data onto the above-described information recording medium of the present invention and receive various benefits owned by the information recording medium, and also it is possible to receive various benefits owned by the information recording medium.

Incidentally, in response to various aspects of the above-described information recording medium of the present invention, the recording apparatus of the present invention can also take various aspects.

Incidentally, the recording apparatus may have a defect management information generating device for generating or making defect management information. Alternatively, the defect management information may be obtained from the information recording medium or via other communication channels. The made or obtained defect management information may be stored into a memory device including a memory such as a Random Access Memory (RAM).

If the information recording medium is an optical recording medium, an optical pickup is preferable as a direct recording device for directly recording the record data or the like onto the information recording medium. If the information recording medium is magnetic, magneto optical, or other types, such as a type of using the change of a dielectric constant, a pickup, a head, or a probe or the like suitable for the type of the information recording medium may be used.

The second recording device may be constructed to record the defect management information into the temporary defect management area (or a definite defect management area) a plurality of times repeatedly or redundantly. This makes it possible to surely maintain the defect management information on the information recording medium.

In one aspect of the recording apparatus of the present invention, the defect management information includes a plurality of defect list entries, each of which includes an evacuation source address which is an address of a position of the defect and an evacuation destination address which is an address of a recording position of evacuation data that corresponds to the record data to be recorded or already recorded at the position of the defect, the recording apparatus is further provided with an obtaining device for obtaining a central address which is the evacuation source address of a defect list entry placed in the center of the defect management information out of the plurality of defect list entries, and the first control device controls the second recording device to divide the defect management information into a first group which is a group of defect list entries having the evacuation source address larger than the central address and a second group which is a group of defect list entries having the evacuation source address smaller than the central address, as the plurality of divisional defect management information, and to record the defect management information.

According to this aspect, it is possible to divide the defect management information more appropriately (i.e. divide it into the first group and the second group) and record it. Namely, since the defect management information is divided into two divisional defect management information on the basis of the central address, it is possible to distribute the plurality of defect list entries uniformly to the two divisional defect management information.

Incidentally, in the defect management information including, e.g., n defect list entries, the “center” in the present invention indicates the position of substantially the n/2-th defect list entry. Namely, this indicates existing in the center of the defect management information (or the divisional defect management information) in terms of location, regardless of the value of the evacuation source address owned by each of the defect list entries.

Incidentally, if the divisional defect management information is further divided, it is preferable to further divide it into two new divisional defect management information by using, as the central address, the evacuation source address of a defect list entry placed in the center of the divisional defect management information out of the defect list entries included in the division defect management information

The present invention is not limited to dividing the defect management information into two divisional defect management information, but may be constructed to divide it into three or more. At this time, it is preferable that the defect list entries are uniformly dispersed and included in each of the three or more divisional defect management information.

In another aspect of the recoding apparatus of the present invention, the recoding apparatus is further provided with a second control device for controlling the second recording device, when a new defect list entry is additionally recorded into the divisional defect management information, to append the new defect list entry into the first group and record it if the evacuation address of the new defect list entry is larger than the central address and append the new defect list entry into the second group and record it if the evacuation address of the new defect list entry is smaller than the central address.

According to this aspect, in updating the divisional defect management information, it is possible to select the divisional defect management information including an updated portion out of the whole defect management information (i.e. the divisional defect management information related to the above-described first group or second group) according to the value of the evacuation source address of the newly-adding defect list entry, and it is possible to record (i.e. update and additionally record) the selected divisional defect management information independently of another divisional defect management information. By this, it is unnecessary to update and record the defect management information as a whole repeatedly, and if minimum updating is performed, it is possible to obtain the same effect as when the whole defect management information is updated. Therefore, as compared to the aspect of updating and recording the whole defect management information, it is possible to reduce the recording capacity required for the updating of the defect management information. In particular, it is possible to efficiently use the temporary defect management area.

In another aspect of the recoding apparatus of the present invention, the recoding apparatus is further provided with a third recording device for recording pointer information for indicating a relationship among the plurality of divisional defect management information.

According to this aspect, it is possible to appropriately record the pointer information. Therefore, it is possible to arrange the plurality of divisional defect management information relatively easily by referring to the pointer information by the operation of the reproducing apparatus described later, for example.

Incidentally, the time when the pointer information is recorded by the third recording device is conceivably when the defect management information is updated, such as the case where a defect is newly detected.

The above object of the present invention can be achieved by a recording method of recording record data onto an information recording medium provided with: (i) a data area for recording therein the record data; and (ii) a temporary defect management area for temporarily recording therein defect management information which is a basis of defect management for a defect in the data area, the recording method provided with: a first recording process of recording the record data; a second recording process of recording the defect management information; a judging process of judging whether or not the defect management information which exceeds a predetermined size is to be recorded by the second recording process; and a first control process of controlling the second recording process to divide the defect management information into a plurality of divisional defect management information in which one divisional defect management information can be updated independently of another divisional defect management information and to record the defect management information, if it is judged in the judging process that the defect management information which exceeds the predetermined size is to be recorded.

According to the recording method of the present invention, it is possible to appropriately record the record data onto the information recording medium of the present invention (including its various aspects), as with the above-described recording apparatus of the present invention, and also it is possible to receive various benefits owned by the information recording medium.

Incidentally, in response to various aspects of the above-described recording apparatus (or information recording medium) of the present invention, the recording method of the present invention can also take various aspects.

(Reproducing Apparatus and Method)

The above object of the present invention can be achieved by a reproducing apparatus for reproducing the record data recorded on the above-described information recording medium of the present invention (including its various aspects), the reproducing apparatus provided with: a first reading device for reading at least one of the plurality of divisional defect management information; and a reproducing device for reproducing the record data recorded in the data area on the basis of the read at least one divisional defect management information, the reproducing device reproducing the record data by arranging the at least one divisional defect management information.

According to the reproducing apparatus of the present invention, it is possible to appropriately reproduce the record data recorded on the above-described information recording medium of the present invention, by using the first reading device, which includes: an optical pickup; a controller for controlling the optical pickup; or the like, and the reproducing device, which includes: a decoder for converting the image data to a image signal which can be displayed on a display; or the like.

Specifically, at first, the first reading device reads the defect management information recorded in the temporary defect management area. The defect management information may be stored into the memory device, such as a memory. In recording, the record data is recorded away from a defect in the data area on the information recording medium. Namely, the record data to be recorded or already recorded at the position of the defect in the data area is evacuated to the spare area for evacuating the record data to be recorded (or already recorded) at the position of the defect, for example. Thus, in order to reproduce the record data recorded in this manner, it is necessary to know the position of the defect in the data area. Thus, the reproducing device recognizes the position of the defect in the data area on the basis of the defect management information and recognizes the recording position at which the record data (i.e. the evacuation data) is recorded away from the defect, thereby to reproduce the record data recorded in the data area or the evacuation data recorded in the spare area.

Particularly in the present invention, the defect management information is recorded as the plurality of divisional defect management information. The reproducing device, in its operation, obtains the original defect management information (or information about a defect indicated by the original defect management information) by arranging or recombining the divisional defect management information. The “arranging the at least one divisional defect management information” in the present invention is not necessarily limited to constructing the original defect management information physically or logically. It includes an aspect in which the original defect management information (or the defect list entry required for reproduction) is recognizable and in which the at least one divisional defect management information is used in the reproducing apparatus. Then, on the basis of the original defect management information, the record data is reproduced while the defect management is performed.

As a result, according to the reproducing apparatus of the present invention, it is possible to appropriately reproduce the record data recorded on the above-described information recording medium of the present invention, and also it is possible to receive various benefits owned by the information recording medium.

Incidentally, in response to various aspects of the above-described information recording medium (or recording apparatus) of the present invention, the reproducing apparatus of the present invention can also take various aspects.

In one aspect of the reproducing apparatus of the present invention, the reproducing apparatus is further provided with a second reading device for reading pointer information, the reproducing device arranging the at least one divisional defect management information on the basis of the pointer information.

According to this aspect, particularly in reproducing the record data recorded on the information recording medium including the pointer information as described above, it is possible to read and arrange at least one (or a plurality of) divisional defect management information relatively easily by referring to the pointer information.

The above object of the present invention can be achieved by a reproducing method of reproducing the record data recorded on the above-described information recording medium of the present invention (including its various aspects), the reproducing method provided with: a first reading process of reading at least one of the plurality of divisional defect management information recorded in the temporary defect management area; and a reproducing process of reproducing the record data recorded in the data area on the basis of the read at least one divisional defect management information, the reproducing process reproducing the record data by arranging the at least one divisional defect management information.

According to the reproducing method of the present invention, it is possible to appropriately reproduce the record data recorded on the above-described information recording medium of the present invention (including its various aspects), and also it is possible to receive various benefits owned by the information recording medium.

Incidentally, in response to various aspects of the above-described reproducing apparatus of the present invention, the reproducing method of the present invention can also take various aspects.

(Computer Program Product)

The above object of the present invention can be achieved by a first computer program product in a computer-readable medium for tangibly embodying a program of instructions executable by a computer provided in the above-described recording apparatus of the present invention (including its various aspects) to make the computer function as at least one of the first recording device, the second recording device, the judging device, and the first control device.

According to the first computer program product of the present invention, the above-described recording apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described recording apparatus.

Incidentally, in response to various aspects of the above-described information recording medium (or recording apparatus) of the present invention, the first computer program product of the present invention can also take various aspects.

The above object of the present invention can be achieved by a second computer program product in a computer-readable medium for tangibly embodying a program of instructions executable by a computer provided in the above-described reproducing apparatus of the present invention (including its various aspects) to make the computer function as at least one of the first reading device and the reproducing device.

According to the second computer program product of the present invention, the above-described reproducing apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described reproducing apparatus.

Incidentally, in response to various aspects of the above-described information recording medium (or reproducing apparatus) of the present invention, the second computer program product of the present invention can also take various aspects.

(Data Structure Including Control Signal)

The above object of the present invention can be achieved by a data structure provided with: a data area for recording therein record data; and a temporary defect management area for temporarily recording therein defect management information which is a basis of defect management for a defect in the data area, the defect management information being divided into a plurality of divisional defect management information in which one divisional defect management information can be updated independently of another divisional defect management information and being recorded, if the defect management information exceeds a predetermined size.

According to the data structure of the present invention, as in the case of the above-described information recording medium of the present invention, it is possible to reduce the recording capacity required for the additional or sequential or postscript recording of the defect management information by dividing and recording the defect management information, and it is possible to efficiently use the information recording medium. Namely it is possible to receive various benefits owned by the information recording medium.

Incidentally, in response to various aspects of the above-described information recording medium of the present invention, the data structure of the present invention can also take various aspects.

The nature, utility, and further features of this invention will be more clearly apparent from the following detailed description with reference to preferred embodiments of the invention when read in conjunction with the accompanying drawings briefly described below.

As explained above, according to the information recording medium of the present invention, it is provided with: the data area; and the temporary defect management area. The plurality of divisional defect management information is recorded in the temporary defect management area. Therefore, it is possible to reduce the recording capacity required for the updating of the defect management information, and it is possible to efficiently use the information recording medium.

According to the recording apparatus of the present invention, it is provided with: the first recording device; the second recording device; the judging device; and the first control device. According to the recording method of the present invention, it is provided with: the first recording process; the second recording process; the judging process; and the first control process. Therefore, it is possible to appropriately record the record data onto the information recording medium of the present invention. According to the reproducing apparatus of the present invention, it is provided with: the first reading device; and the reproducing device. According to the recording method of the present invention, it is provided with: the first reading process; and the reproducing process. Therefore, it is possible to appropriately read and reproduce the record data from the information recording medium of the present invention.

### BRIEF DESCRIPTION OF THE DRAWINGS

FIG. 1 is an explanatory diagram showing an embodiment of an information recording medium of the present invention;

FIG. 2 is an explanatory diagram showing the content of defect management information in the embodiment;

FIG. 3 is an explanatory diagram showing one example of a defect list in the embodiment;

FIG. 4 is an explanatory diagram conceptually showing a recording unit of a temporary defect management area in the embodiment;

FIG. 5 is an explanatory diagram conceptually showing an aspect of recording a defect list entry to an ECC cluster in the embodiment;

FIG. 6 is an explanatory diagram conceptually showing the data structure of the temporary defect management area in which the defect list or the like is recorded in the embodiment;

FIG. 7A to FIG. 7F are explanatory diagrams conceptually showing the defect list recorded on an optical disc and a process until the defect list is recorded;

FIG. 8 is an explanatory diagram conceptually showing the generation of a defect in a user data area corresponding to the defect list shown in FIG. 7A to FIG. 7F;

FIG. 9A to FIG. 9D are explanatory diagrams conceptually showing a comparison example of recording the defect list shown in FIG. 7A to FIG. 7F;

FIG. 10 is an explanatory diagram conceptually showing the data structure of setting information if pointer information in the embodiment is included in the setting information;

FIG. 11 is an explanatory diagram conceptually showing the data structure of the defect list if the pointer information in the embodiment is included in the defect list;

FIG. 12 is a block diagram showing a recording / reproducing apparatus which is an embodiment of a recording apparatus and a reproducing apparatus of the present invention;

FIG. 13 is a block diagram showing a disc drive of the recording/reproducing apparatus in the embodiment;

FIG. 14 is a block diagram showing a backend of the recording/reproducing apparatus in the embodiment;

FIG. 15 is a flowchart showing an initial setting operation of the recording/reproducing apparatus in the embodiment;

FIG. 16 is a flowchart showing a record operation or the like of the recording/reproducing apparatus in the embodiment;

FIG. 17 is a flowchart showing an operation of dividing and recording the defect list of the recording/reproducing apparatus in the embodiment;

FIG. 18 is an explanatory diagram showing one process of recording content on the optical disc during the operation of dividing and recording the defect list on the recording/reproducing apparatus in the embodiment;

FIG. 19 is an explanatory diagram showing another process of the recording content on the optical disc during the operation of dividing and recording the defect list on the recording/reproducing apparatus in the embodiment;

FIG. 20 is an explanatory diagram showing another process of the recording content on the optical disc during the operation of dividing and recording the defect list on the recording/reproducing apparatus in the embodiment;

FIG. 21 is an explanatory diagram showing another process of the recording content on the optical disc during the operation of dividing and recording the defect list on the recording/reproducing apparatus in the embodiment;

FIG. 22 is an explanatory diagram showing another process of the recording content on the optical disc during the operation of dividing and recording the defect list on the recording/reproducing apparatus in the embodiment;

FIG. 23 is an explanatory diagram showing another process of the recording content on the optical disc during the operation of dividing and recording the defect list on the recording/reproducing apparatus in the embodiment;

FIG. 24 is an explanatory diagram showing another process of the recording content on the optical disc during the operation of dividing and recording the defect list on the recording/reproducing apparatus in the embodiment;

FIG. 25 is an explanatory diagram showing another process of the recording content on the optical disc during the operation of dividing and recording the defect list on the recording/reproducing apparatus in the embodiment;

FIG. 26 is an explanatory diagram showing another process of the recording content on the optical disc during the operation of dividing and recording the defect list on the recording/reproducing apparatus in the embodiment;

FIG. 27 is an explanatory diagram showing the recording content of the pointer information at a time point of ending the operation of dividing and recording the defect list;

FIG. 28 is a flowchart showing the finalizing of the recording/reproducing apparatus in the embodiment;

FIG. 29 is a flowchart showing a reproduction operation of the recording/reproducing apparatus in the embodiment; and

FIG. 30 is an explanatory diagram showing another embodiment of the information recording medium of the present invention.

### DETAILED DESCRIPTION OF THE PREFERRED EMBODIMENTS

Embodiments of the present invention will be explained with reference to the drawings hereinafter. In the embodiments below, the information recording medium of the present invention is applied to a write-once-type optical disc, and the recording apparatus and the reproducing apparatus of the present invention are applied to a recording/reproducing apparatus for the write-once-type optical disc.

(Embodiment of Information Recording Medium)

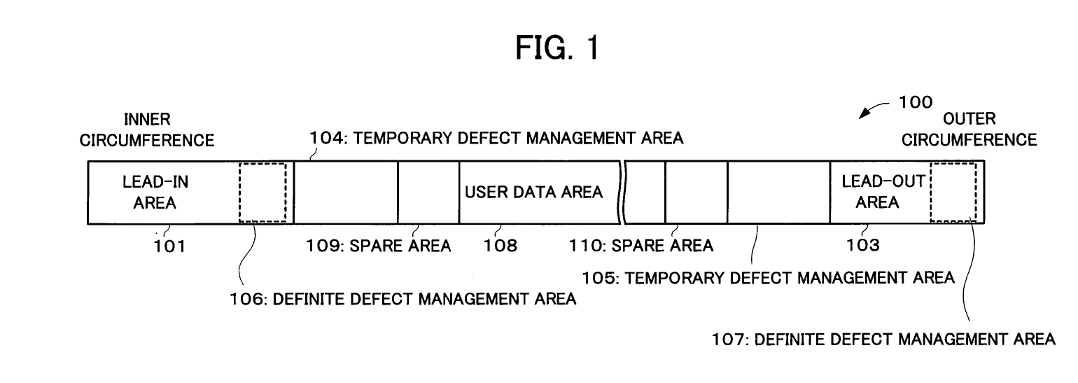

Firstly, the recording structure of the write-once type optical disc in the embodiment of the present invention and the information and data recorded on the optical disc will be explained. FIG. 1 shows the recording structure of the write-once-type recording medium which is the embodiment of the present invention. Incidentally, the left side of FIG. 1 is the inner circumferential side of a write-once-type optical disc 100, and the right side of FIG. 1 is the outer circumferential side of the optical disc 100.

As shown in FIG. 1, there is a lead-in area 101 on the most inner circumferential side on a recording surface of the write-once-type optical disc 100, and there are a temporary defect management area 104, a spare area 109, a user data area 108, a spare area 110, a temporary defect management area 105, and a lead-out area 103, placed toward the outer circumferential side.

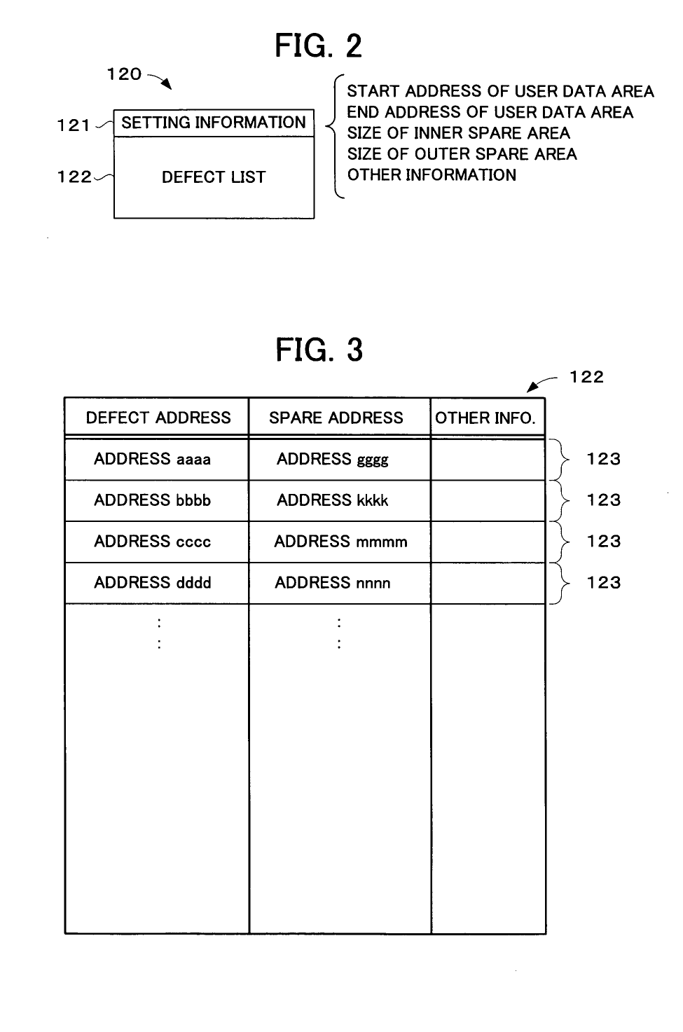

In both the lead-in area 101 and the lead-out area 103, the control information for controlling the recording and reading/reproducing of information or data with respect to the optical disc 100 is recorded. The lead-in area 101 is provided with a definite defect management area 106. The lead-out area 103 is also provided with a definite defect management area 107. In both the defect management areas 106 and 107, defect management information 120 (refer to FIG. 2) is to be recorded.

Into the user data area 108, the record data, such as image (or video) data, audio data, and contents data, is recorded. The user data area 108 is a main area for recording therein the record data. The spare areas 109 and 110 are alternative recording areas for evacuating thereto the record data from a defect in the user data area 108. Namely, when there is a defect in the user data area 108, the record data to be recorded or already recorded at the position of the defect (which is hereinafter referred to as the “evacuation data”, as occasion demands) is alternatively recorded into the spare area 109 or 110.

Into the both the temporary defect management areas 104 and 105, the defect management information 120 is recorded temporarily. Incidentally, the defect management information 120 is also recorded into the definite defect management areas 106 and 107. Differences between the definite defect management areas 106/107 and the temporary defect management areas 104/105 will be described later. Moreover, in the embodiment, the defect management information 120 that is divided is also recorded into the temporary defect management area 104 or 105. Such an aspect of recording is also described later.

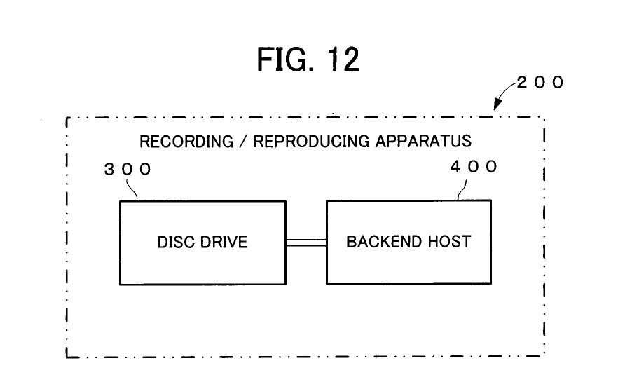

Next, the defect management information 120 will be explained. The defect management information 120 is used for the defect management performed by a recording/reproducing apparatus 200 (refer to FIG. 12). The recording/reproducing apparatus 200 performs the defect management when recording the record data onto the optical disc 100 or when reproducing the record data from the optical disc 100. In the embodiment, the defect management is mainly as follows. When there is a defect, such as scratches, dusts, or deterioration, on the user data area 108 on the optical disc 100, the record data is recorded away from the position of the defect, and at the same time, the evacuation data is recorded into the spare area 109 or 110. Moreover, the following operations are also performed as a part of the defect management: an operation of recognizing the position of the defect when the record data recorded in the user data area 108 is reproduced; and an operation of reading the record data to be originally recorded or already recorded at the position of the defect from the spare area 109 or 110. In order to perform such a defect management, the recording/reproducing apparatus 200 needs to recognize the position of the defect in the user data area 108. The defect management information 120 is mainly used for the recording/reproducing apparatus 200 to recognize the position of the defect.

FIG. 2 shows the content of the defect management information 120. As shown in FIG. 2, setting information 121 and a defect list 122 are included in the defect management information 120.

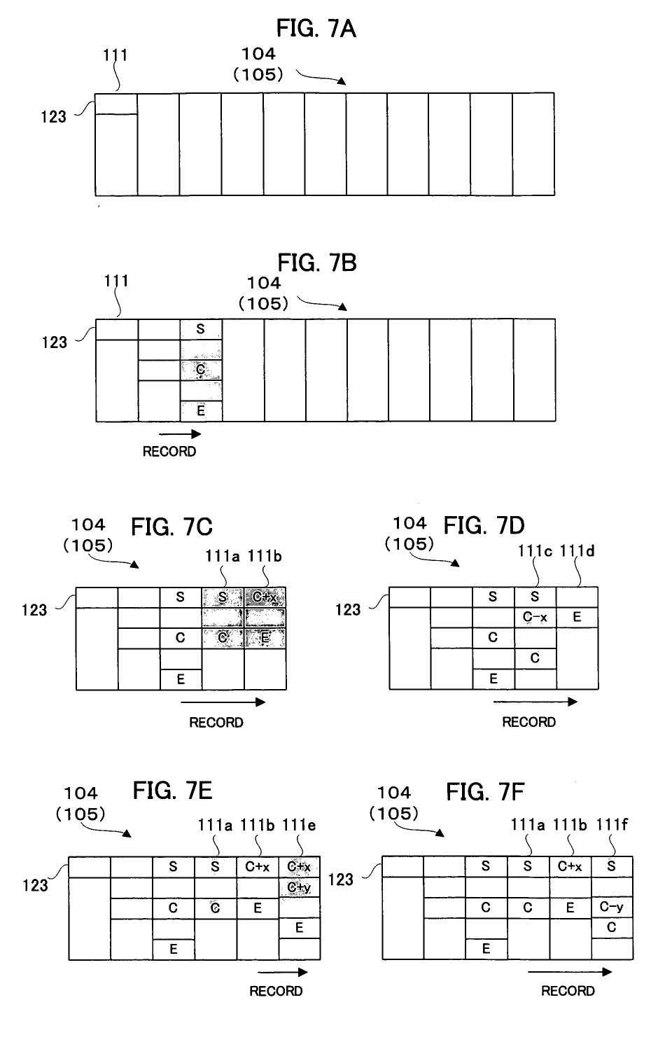

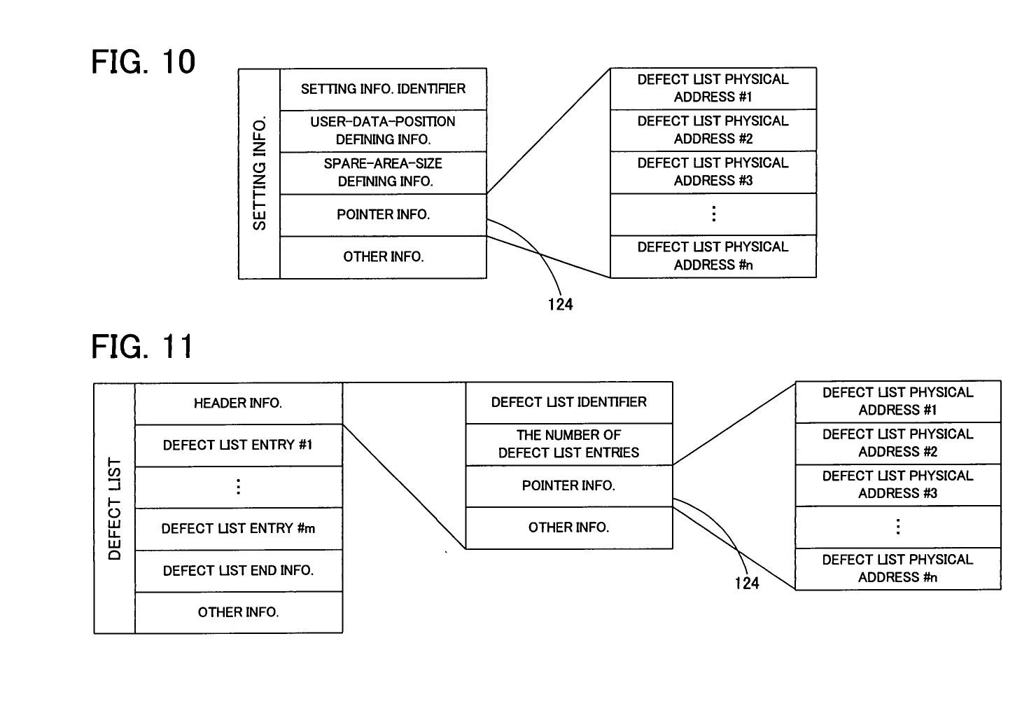

The setting information 121 includes: a start address of the user data area 108; an end address of the user data area 108; the size of the inner spare area 109; the size of the outer spare area 110; and other information, as shown in FIG. 2. In addition, the setting information 121 may include pointer information for indicating a relationship among parts into which the defect list 122 is divided as described later (refer to FIG. 7). Hereinafter, each of the parts is referred to as a divisional list of the defect list 122. Incidentally, the detailed data structure of the setting information 121 will be described in detail later (refer to FIG. 10).

FIG. 3 shows the content of the defect list 122. As shown in FIG. 3, on the defect list 122, there are recorded an address for indicating the position of a defect in the user data area 108 (which is hereinafter referred to as a “defect address”), an address for indicating the recording position in the spare area 109 or 110 of the evacuation data (which is hereinafter referred to as a “spare address”); and other information. Namely, the defect address indicates one example of the “evacuation source address” in the present invention, and the spare address indicates one example of the “evacuation destination address” in the present invention. When there are a plurality of defects in the user data area 108, a plurality of defect addresses and spare addresses corresponding to the defects are included in the defect list 122.

A combination of one defect address, one spare address, and one of the other information is referred to as a defect list entry 123. Namely, one defect list entry 123 is made if one defect is generated in the user data area 108.

Incidentally, the defect management can be performed not only for the user data area 108 on the optical disc 100 but also for all of the recording surfaces of the optical disc 100.

Then, the difference between the temporary defect management area 104/105 and the definite defect management area 106/107 will be explained specifically.

The temporary defect management areas 104 and 105 are areas for recording therein the defect management information 120 temporarily until the optical disc 100 is finalized. Here, “to finalize” includes general operations for arranging the address information, control information, or the like of the record data recorded on the optical disc 100 and for finishing to a general-purpose information recording medium. For example, by finalizing the write-once type optical disc 100, it is possible to reproduce the data on a reproduce-only reproducing apparatus and various reproducing apparatuses corresponding to other optical discs.

The defect management information 120 is necessary for the defect management. The presence or absence and the position of a defect are different for each optical disc, so that it is necessary to record and maintain the defect management information 120 on each optical disc. In the example, at a stage before the finalizing, the defect management information 120 is recorded and maintained in the temporary defect management area 104 or 105 on the optical disc 100.

Until the optical disc 100 is finalized, the defect management information 120 may be updated several times in some cases. For example, if dusts are attached onto the optical disc 100 between the first recording and the second recording (i.e., additional or sequential or postscript recording), the defect (or dusts) is detected upon the second recording. On the basis of this detection, the defect list 122 is updated. When the defect list 122 is updated, the defect management information 120 including the updated defect list 122 is additionally recorded (i.e. written once) into the temporary defect management area 104 or 105. The optical disc 100 is a write-once-type recording medium, so that it is impossible to overwrite the updated defect management information 120 on the existing defect management information 120. Thus, the updated defect management information 120 is recorded in series after the existing defect management information 120.

In order to realize such repeated and serial recording of the defect management information 120, the temporary defect management areas 104 and 105 are larger than the definite defect management areas 106 and 107.

The definite defect management areas 106 and 107 are areas for recording therein the defect management information 120 definitely when the optical disc 100 is finalized. Namely, at a stage before the finalizing, the definite defect management areas 106 and 107 are unrecorded (or blank). When the optical disc 100 is finalized, the defect management information 120 (i.e. the effective defect management information 120) is recorded in the definite defect management areas 106 and 107, and the recording situation is continued subsequently.

According to the optical disc 100 in the embodiment, the temporary defect management area 104 is placed between the lead-in area 101 and the spare area 109 and the temporary defect management area 105 is placed between the spare area 110 and the lead-out area 103, which allows the compatibility between the write-once-type optical disc 100 and a general rewritable optical disc. In order to realize the compatibility with a general rewritable-type optical disc, the write-once-type optical disc 100 needs to have the lead-in area, the spare area, the user data area, the spare area, and the lead-out area, and needs to maintain a basic recording structure, such as the order, position, and size (area) of the areas. The optical disc 100 maintains such a basic recording structure although it is provided with the temporary defect management areas 104 and 105, which allows the compatibility. Namely, if the temporary defect management area 104 is placed in the lead-in area 101, because the temporary defect management area 104 is relatively large as described above, there is no choice to extend the size of the lead-in area 101, which is unfavorable. In this example, however, such a disadvantage does not occur because the temporary defect management area 104 is placed out of the lead-in area 101. Moreover, if the temporary defect management area 104 is placed in the user data area 108, the defect management information 120 having properties of control information is included in the user data area 108 which is an area in which record data is supposed to be recorded, causing the disadvantage that the control information and the record data, which is information having properties different from those of the control information, are mixed in the user data area 108. In this example, however, such a disadvantage does not occur because the temporary defect management area 104 is placed out of the user data area 108. The same is true for the defect management area 105.

The start address and end address of the user data area 108, and the each start address of the spare areas 109 and 110 (or the size of the user data area 108 and the spare areas 109 and 110, or the like) are included in the setting information 121 in the defect management information 120 (refer to FIG. 2). This setting information 121 can be set by the recording/reproducing apparatus 200. Namely, it is allowed to change (i) the start address and end address of the user data area 108 and (ii) the each size of the spare areas 109 and 110 if they are clearly shown as the setting information 121. Even if they are changed, it is possible to maintain the compatibility with a general rewritable-type recording medium. Therefore, it is possible to ensure a space between the lead-in area 101 and the user data area 108 by shifting the start address of the user data area 108 backward (to the outer circumferential side), and it is possible to place the temporary defect management area 104 in the space. Depending on how to set the start address of the user data area 108, it is possible to reserve or ensure the relatively wider (large-sized) temporary defect management area 104. The same is true for the temporary defect management area 105.

According to the optical disc 100, the definite defect management areas 106 and 107 are placed in the lead-in area 101 and the lead-out area 103, respectively, which allows the compatibility between the write-once-type optical disc 100 and a general rewritable optical disc. Namely, a general rewritable optical disc has areas to record the defect management information, the areas being placed in both the lead-in area and the lead-out area. The optical disc 100 also has the definite defect management areas 106 and 107 placed in the lead-in area 101 and the lead-out area 103, respectively. At this point, their recording structures coincide. Therefore, it is possible to ensure the compatibility between the write-once-type optical disc 100 and a general rewritable-type optical disc.

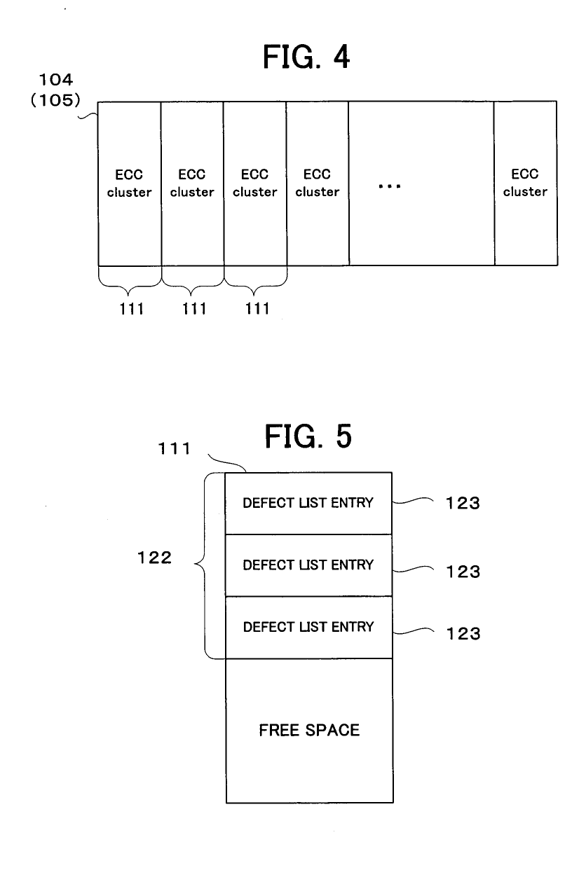

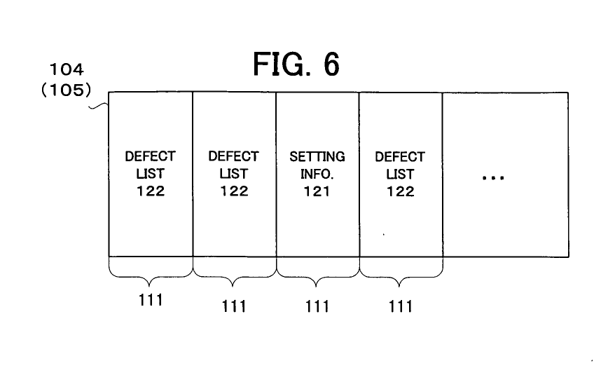

Next, with reference to FIG. 4 to FIG. 6, the aspect of the temporary defect management areas 104 and 105, and the defect list entry 123 recorded therein will be explained. FIG. 4 conceptually shows a recording unit of the temporary defect management area 104 or 105. FIG. 5 conceptually shows an aspect of recording the defect list entry 123 to the recording unit. FIG. 6 conceptually shows the data structure of the temporary defect management area in which the defect list 122 or the like is recorded.

As shown in FIG. 4, the temporary defect management areas 104 and 105 include a plurality of ECC clusters 111, each of which is the smallest recording unit. Namely, the ECC cluster is a basic unit of accessing when a recording/reproducing apparatus described later records or reproduces the record data. The ECC cluster unit is 64 kB, for example, or may have other sizes. As described later, the defect management information 120 (or the defect list entry 123) is recorded by the ECC cluster 111 unit.

As shown in FIG. 5, it is possible to record a plurality of defect list entries 123 in one ECC cluster 111. If the size of the defect list 122 (i.e. the plurality of defect list entries 123 included in the defect management information 120) is smaller than that of the ECC cluster 111, it is preferable that any data is not recorded into a portion except an area in which the defect list 122 is recorded, as a free space. Alternatively, null data or the like may be written.

On the other hand, if the size of the defect list 122 is larger than that of the ECC cluster 111, the defect list 122 is recorded by using two or more ECC clusters 111.

As shown in FIG. 6, the defect list 122 and the setting information 121 or the like are recorded by the ECC cluster unit 111. The defect list 122 and the setting information 121 corresponding to the defect list 122 constitute the defect management information 120 (refer to FIG. 2).

Incidentally, this is not illustrated, but it is preferable that the defect management information 120 is recorded twice repeatedly or redundantly in a row. Namely, the same defect list 122 and the same setting information 121 are preferably recorded into the temporary defect management area 104 or 105. This makes it possible to surely record and read the defect management information 120. In addition, the defect management information 120 is also preferably recorded twice repeatedly or redundantly in a row even when recorded into the definite defect management area 106 or 107, as described above. Even if the recording is not performed twice, for example, once, or three times or more, it is possible to appropriately record and reproduce the defect management information 120 and the evacuation data.

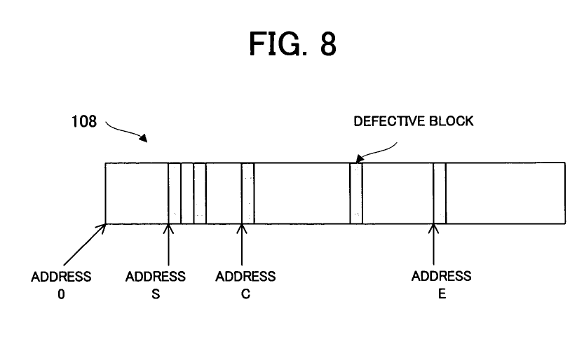

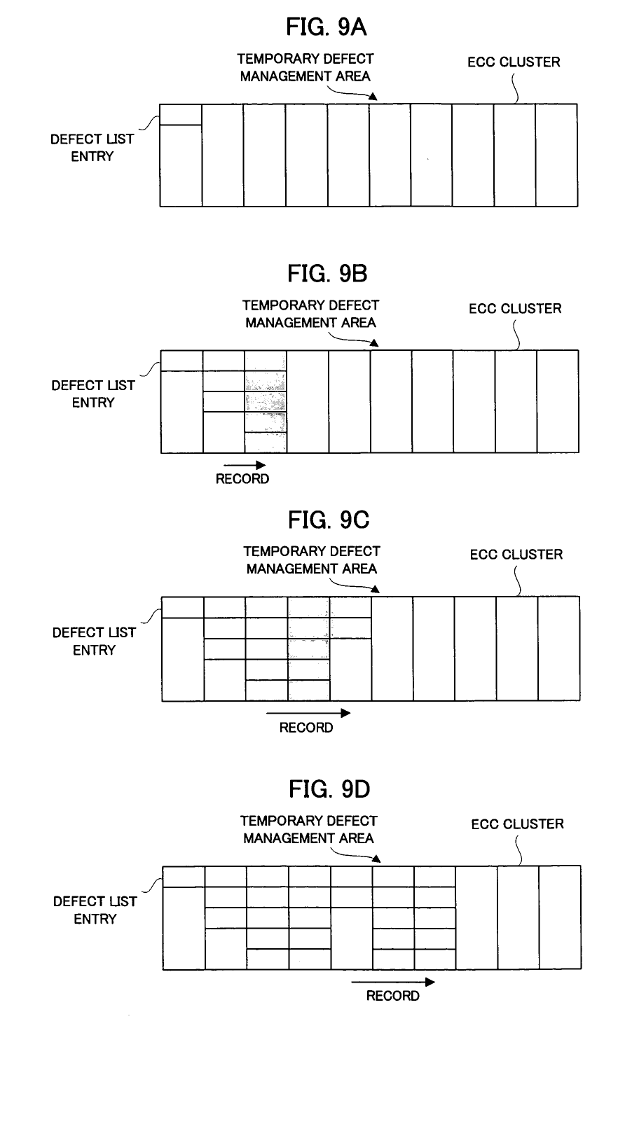

Next, with reference to FIG. 7A to FIG. 9D, the structure of the defect list entry 123 recorded in the temporary defect management area 104 or 105 on the optical disc 100 associated with the embodiment will be explained. FIG. 7A to FIG. 7F conceptually show a process in which the defect list 122 is recorded onto the optical disc 100. FIG. 8 conceptually shows the generation of a defect in the user data area 108 corresponding to the defect list 122 shown in FIG. 7A to FIG. 7F. FIG. 9A to FIG. 9D conceptually show a comparison example for the process of recording the defect list shown in FIG. 7A to FIG. 7F.

The defect list 122 recorded in the temporary defect management area 104 or 105 will be explained hereinafter.

As shown in FIG. 7A, if a defect is detected in the user data area 108, a defect list entry 123 is generated and recorded as the defect list 122. At this time, the defect list entry 123 is recorded by the ECC cluster 111 unit, and the other area except the area in which the defect list entry 123 is recorded is a free space. It is preferable that the setting information 121 is also recorded at the same time, which is not illustrated.

After that, if a new defect is detected, a defect list entry 123 corresponding to the new defect is generated, and the defect list 122 having a larger data amount is recorded sequentially and additionally, as shown in FIG. 7B. At this time, the new defect list 122 including the new defect list entry 123 is recorded in another ECC cluster 111.

Incidentally, FIG. 7B shows such a condition that the defect list 122 is updated twice from the condition shown in FIG. 7A. The effective defect list 122 (i.e. the newest defect list 122) is shown with the defect list in the most right portion. The defect list 122 before the updating (i.e. the defect lists 122 in the most left portion and in the middle portion) may be treated as the ineffective defect list 122 by a recording/reproducing apparatus described later.

At this time, the defect list entries 123 included in the defect list 122 are preferably sorted by the defect address (refer to FIG. 3). Namely, the defect list entries 123 are preferably sorted according to an address position at which a defect is detected in the user data area 108.

Then, as shown in FIG. 7B, it is assumed that the defect list 122 of the largest size which can be registered in one ECC cluster is recorded. Incidentally, “S”, “C”, and “E” shown in FIG. 7B indicate the defect addresses included in the defect list entries 123.

If a new defect is detected after that, the defect list 122 cannot be recorded in only one ECC cluster 111. In this case, the defect list 122 is divided on the basis of the defect address of the defect list entry 123 in the center out of the defect list entries 123 recorded in the present ECC cluster 111. The “center” means that if five defect list entries 123 are sorted and recorded, for example shown in FIG. 7B, the third defect list entry 123 exists in the center. Namely, substantially the n/2-th defect list entry 123 out of n defect list entries 123 is the defect list entry 123 existing in the center.

Namely, in FIG. 7B, the defect address of the defect list entry 123 existing in the center is “C”. Therefore, if a defect address for indicating a newly detected defect is larger than “C” (e.g. if the defect address is “C+x”), the defect list 122 is divided as shown in FIG. 7C. Namely, a group of the defect list entries 123 having a defect address smaller than or equal to “C” is recorded in one ECC cluster 111a. A group of the defect list entries 123 having a defect address larger than “C” and a defect list entry 123 about the newly detected defect are recorded in another ECC cluster 111b.

On the other hand, if a defect address for indicating a newly detected defect is smaller than “C” (e.g. if the defect address is “C−x”), the defect list 122 is divided as shown in FIG. 7D. Namely, the group of the defect list entries 123 having a defect address smaller than or equal to “C” and a defect list entry 123 about the newly detected defect are recorded in one ECC cluster 111c. The group of the defect list entries 123 having a defect address larger than “C” is recorded in another ECC cluster 111d. Incidentally, in order to divide the defect list 122 uniformly, the defect list 122 may be divided with the entry of “C” included in the ECC entry 111d. Namely, the defect list 122 may be divided into the group of the defect list entries 123 having a defect address smaller than “C” and the group of the defect list entries 123 having a defect address larger than or equal to “C”. It is preferable to divide the defect list 122 so that the defect list entries 123 are dispersed uniformly to two or more ECC clusters 111.

After this, with respect to the condition in FIG. 7C, if a defect list entry 123 having a larger defect address than “C” is generated (e.g. if the defect address is “C+y”), one portion of the new defect list (i.e. the divided defect list) is additionally recorded as shown in FIG. 7E. Namely, the group of the defect list entries 123 recorded in the ECC cluster 111b is extracted and additionally recorded into a new ECC cluster 111e.

On the other hand, with respect to the condition in FIG. 7C, if a defect list entry 123 having a smaller defect address than “C” is generated (e.g. if the defect address is “C−y”), one portion of the new defect list (i.e. the divided defect list) is additionally recorded as shown in FIG. 7F. Namely, the group of the defect list entries 123 recorded in the ECC cluster 111a is extracted and additionally recorded into a new ECC cluster 111f.

Then, if the defect list 122 having a larger size than that of the ECC cluster 111 is to be recorded (wherein one portion of the defect list 122 is to be recorded), the defect list 122 (i.e. one portion of the defect list 122) is divided again in the same manner as described above.

At this time, the defects are generated in the user data area 108 as shown in FIG. 8. Namely, if a new defect is detected at a position on the right of the position of the “address C”, the defect list 122 is divided as shown in FIG. 7C. On the other hand, if a new defect is detected at a position on the left of the position of the “address C”, the defect list 122 is divided as shown in FIG. 7D.

As a comparison example of the optical disc 100 associated with the embodiment, an aspect of recording the defect list 122 in an optical disc on which the defect list 122 is not divided as shown in FIG. 7C to FIG. 7F will be explained.

As shown in FIG. 9A and FIG. 9B, even in the optical disc associated with the comparison example, as with the optical disc 100, if a new defect is detected, the defect list in which the corresponding new defect list entry is appended is additionally recorded.

If a defect is further detected in the condition shown in FIG. 9B, as shown in FIG. 9C, the defect list is recorded by using two ECC clusters. The defect list extending to the two ECC clusters is updated as an entire defect list, by using two ECC clusters even afterward.

Namely, as shown in FIG. 9D, the entire defect list is updated and recorded by using two ECC clusters again. Thus, as the size of the defect list increases, the recording capacity of the temporary defect management area required for the updating of the defect list increases more.

However, according to the optical disc 100 associated with the embodiment, it is unnecessary to always record the defect list 122 into two or more ECC clusters additionally. It is possible to record the defect list 122 reflecting the detection of a new defect, by additionally recording at least one of the divisional lists of the defect list 122. Namely, in updating the defect list 122 having a size of 10 ECC clusters 111, the 10 ECC clusters are always necessary in the optical disc associated with the above-described comparison example. However, the 10 ECC clusters are not always necessary in the optical disc 100 associated with the embodiment. The defect list 122 can be updated by using one ECC cluster 111, for example, which is greatly advantageous.

By showing more specific numerical values, the difference between the optical disc associated with the comparison example and the optical disc 100 associated with the embodiment will be explained. Incidentally, the explanation below is performed by using the numerical values in the recording of the defect list 122 in the case that the temporary defect management area 104 or 105 is most required (i.e. in the worst case). Specifically, the “worst case” is possibly assumed to be a case where a new defect list entry 123 is additionally recorded only on the side of one of the divisional lists of the defect list 122.

At first, the case where the total number of the defect list entries 123 which can be recorded in one ECC cluster 111 is n (n: integral number, n≧2) and where the total number of the cluster of the spare area 109 and 110 is 2n will be explained. The cluster of the spare area 109 or 110 is a unit used in recording the record data evacuated from the user data are 108. If the record data is evacuated to one cluster of the spare area 109 or 110, one defect list entry 123 in the defect management information 120 is additionally recorded.

In this case, 3n ECC clusters 111 are required in order to record the defect list entries 123 in the optical disc associated with the comparison example. On the other hand, 2n+2 ECC clusters 111 are required in order to record the defect list entries 123 in the optical disc 100 associated with the embodiment. As a result, in the optical disc 100 associated with the embodiment, the defect management information 120 can be updated by a smaller data amount than that of the optical disc associated with the comparison example.

Moreover, in the case where the total number of the defect list entries 123 which can be recorded in one ECC cluster 111 is n (n: integral number, n≧2) and where the total number of the cluster of the spare area 109 and 110 is 3n, 6n ECC clusters 111 are required in order to record the defect list entries 123 in the optical disc associated with the comparison example. On the other hand, 3n+4 ECC clusters 111 are required in order to record the defect list entries 123 in the optical disc 100 associated with the embodiment. As a result, in the optical disc 100 associated with the embodiment, the defect management information 120 can be updated by a smaller data amount than that of the optical disc associated with the comparison example.

Moreover, in the case where the total number of the defect list entries 123 which can be recorded in one ECC cluster 111 is n (n: integral number, n≧2) and where the total number of the cluster of the spare area 109 and 110 is 4n, 10n ECC clusters 111 are required in order to record the defect list entries 123 in the optical disc associated with the comparison example. On the other hand, 4n+6 ECC clusters 111 are required in order to record the defect list entries 123 in the optical disc 100 associated with the embodiment. As a result, in the optical disc associated with the embodiment, the defect management information 120 can be updated by a smaller data amount than that of the optical disc associated with the comparison example.

The above examples are generally summarized. The case where the total number of the defect list entries 123 which can be recorded in one ECC cluster 111 is n (n: integral number, n≧2) and where the total number of the cluster of the spare area 109 and 110 is kn (k: natural number, preferably k≧2) will be explained. In the optical disc associated with the comparison example, the number of the required ECC clusters 111 is 1×n+2×n+ . . . +k×n=kn(k+1)/2. On the other hand, in the optical disc 100 associated with the embodiment, the number of the required ECC clusters 111 is n+(n+2)+(n+2)+ . . . (n+2)=n+(k·1)×(n+2)=k(n+2)·2.

Shown with “(the numerical value of the optical disc 100 associated with the embodiment)-(the numerical value of the optical disc associated with the comparison example)”, the difference between the two numerical values is (kn·4)(k·1)/2. If k is a natural number and k≧2, (kn·4)(k·1)/2≧0 in consideration that n is an integral number and n≧2. Namely, the optical disc 100 associated with the embodiment always has the same or smaller cluster number which is required for the additional or sequential or postscript recording of the defect list 122 than that of the optical disc associated with the comparison example. Namely, it is possible to reduce the data amount required for the updating of the defect management information 120.

Moreover, pointer information 124 for defining a relationship among the divisional lists of the defect list 122 is recorded on the optical disc 100. The pointer information 124 will be explained with reference to FIG. 10 and FIG. 11. FIG. 10 conceptually shows the data structure of the setting information 121 if the pointer information 124 included in the setting information 121. FIG. 11 conceptually shows the data structure of the defect list 122 if the pointer information 124 is included as one portion of the defect list 122.

As shown in FIG. 10, the pointer information 124 may be included in the setting information 121.

As explained in FIG. 2, the setting information 121 includes: user-data-position defining information for defining the start address and end address or the like of the user data area 108; spare-area-size defining information for defining the size or the like of the spare areas 109 and 110; and other information. The setting information 121 further includes a setting information identifier and the pointer information 124.

The setting information identifier is information for indicating that the data structure is the setting information 121.

The pointer information 124 is information for defining a relationship among the divisional lists of the defect list 122 which are recorded in the plurality of ECC clusters 111. The pointer information 124 includes a defect list physical address #k (k=1, 2, . . . , n).

The head address of the ECC cluster 111 in which the effective defect list 122 is recorded as the defect list physical address #k (k=1, 2, . . . , n), wherein the head address is shown with the physical address of the head sector of the ECC cluster 111. Incidentally, it is preferable to select and record the head address of each of the divisional lists of the defect list 122 which constitute the newest or effective defect management information 120.

The number of the defect list physical addresses (i.e. n) is equal to the number of the divisions (or the divisional lists) of the defect list 122. For example, the pointer information 124 corresponding to the defect list 122 shown in FIG. 7C and FIG. 7D has two physical addresses.

In addition, the defect list physical address is preferably is sorted according to the values of the defect addresses of the defect list entries 123 included in the divided defect list 122. For example, the defect list physical addresses are preferably sorted from a smaller one and recorded. Namely, the defect list physical addresses are preferably sorted to make the original defect list 122 by arranging the divisional lists of the defect list 122 according to the order indicated by the pointer information 124.

Moreover, as shown in FIG. 11, the pointer information 124 may be included in the defect list 122. In this case, the pointer information 124 is included in header information of the defect list 122. Incidentally, the header information includes a defect list identifier, the number of defect list entries, and other information, in addition to the pointer information 124.

The defect list identifier shows a unique character string or a series of numbers or the like for identifying the defect list 122. Moreover, the number of defect list entries shows the total number of the defect list entries 123 included in the defect list 122.

Incidentally, the pointer information 124 may be recorded in one of the plurality of ECC clusters 111 in which the divisional lists of the defect list 122 are recorded, as one portion of the divisional lists of the defect list 122. However, each of the divisional lists of the defect list 122 may have the head information. In this case, the pointer information 124 may be included in the head information owned by each of the divisional lists of the defect list 122.

As a result, according to the information recording medium associated with the embodiment, it is possible to reduce the data amount (or the recording capacity) required for the recording of the defect list 122 by dividing and recording the defect list 122. In particular, in case of additionally recording the defect list 122, it is possible to reduce the total number of the ECC clusters 111 required for the additional or sequential or postscript recording. Therefore, the present invention has such a great advantage that it is possible to efficiently use the information recording medium.

(Embodiment of Information Reproducing Apparatus)

Next, the structure of a recording/reproducing apparatus in the embodiment of the present invention will be explained. FIG. 12 shows a recording/reproducing apparatus 200, which is an embodiment of the present invention. The recording/reproducing apparatus 200 is provided with: a function of recording the record data onto the optical disc 100; and a function of reproducing the record data recorded on the optical disc 100.

The recording/reproducing apparatus 200 is provided with: a disc drive 300; and a backend host 400.

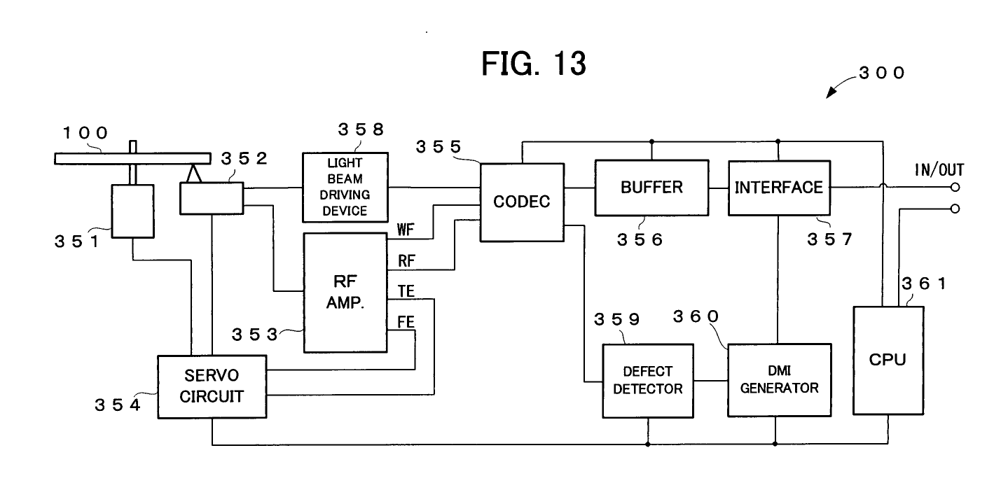

FIG. 13 shows the inner structure of the disc drive 300. The disc drive 300 records record data or the like onto the optical disc 100 and reads the record data or the like recorded on the optical disc 100.

As shown in FIG. 13, the disc drive 300 is provided with: a spindle motor 351; an optical pickup 352; a Radio Frequency (RF) amplifier 353; and a servo circuit 354.

The spindle motor 351 is a motor for rotating the optical disc 100.

The optical pickup 352 records the record data or the like onto the recording surface of the optical disc 100 by irradiating a light beam onto the recording surface and reads the record data or the like recorded on the recording surface by receiving reflected light of the light beam. The optical pickup 352 outputs a RF signal corresponding to the reflected light of the light beam.

The RF amplifier 353 amplifies the RF signal outputted from the optical pickup 352 and outputs it to a CODEC (i.e., a device mainly having functions of an encoder and a modulator in recording as well as a demodulator and a decoder in reading) 355. Moreover, the RF amplifier 353 makes, from the RF signal, a wobble frequency signal WF, a track error signal TE, and a focus error signal FE, and outputs them.

The servo circuit 354 is a servo control circuit for controlling the operating of the optical pickup 352 and the spindle motor 351 on the basis of the track error signal TE, the focus error signal FE, and other servo control signals.

As shown in FIG. 13, the disc drive 300 is provided with: the CODEC 355; a buffer 356; an interface 357; and a light beam driving device 358.

The CODEC 355 is a circuit, provided with: a function of performing an error correction for the record data in reading/reproducing; and a function of appending an error correction code or mark to the record data in recording so as to demodulate and decode the record data. Specifically, the CODEC 355 demodulates and decodes the RF signal outputted from the RF amplifier 353 in reading/reproducing, performs an error correction for the decoded RF signal, and then outputs this to the buffer 356. Moreover, if the error correction is incapable or if the number of error-corrected codes exceeds a certain standard value as a result of performing the error correction for the decoded RF signal, the CODEC 355 generates an error signal for indicating that, and outputs this signal to a defect detector 359. In recording, the CODEC 355 appends the error correction code to the record data outputted from the buffer 356, demodulates and decodes this data to have a code suited to the optical characteristics or the like of the optical disc 100, and then outputs the decoded record data to the light beam driving device 358.

The buffer 356 is a memory circuit for storing the record data temporarily.

The interface 357 is a circuit for controlling the input/output or communication of the record data or the like between the disc drive 300 and the backend host 400. Specifically, in reproducing, the interface 357 responds a request command from the backend host400 and outputs the record data outputted from the buffer 356 (i.e. the record data read from the optical disc 100) to the backend host 400. In recording, the interface 357 receives the record data which is inputted from the backend host 400 to the disc drive 300, and outputs this data to the buffer 356. The interface 357 responds a request command from the backend host 400 and outputs all or part of the defect list maintained in a generator 360 for generating Defect Management Information (DMI generator 360) to the backend host 400.

At the time of recording, the light beam driving device 358 generates a light beam driving signal corresponding to the record data outputted from the CODEC 355 and outputs this signal to the optical pickup 352. The optical pickup 352 modulates a light beam on the basis of the light beam driving signal and irradiates it onto the recording surface of the optical disc 100. This causes the recording of record data or the like on the recording surface.

As shown in FIG. 13, the disc drive 300 is provided with: the defect detector 359; and the DMI generator 360.

The defect detector 359 is a circuit for detecting a defect on the optical disc 100. The defect detector 359 generates a defect detection signal for indicating the presence or absence of a defect and outputs this signal. The defect detector 359 detects a defect on the basis of the result of the error correction of record data in reading information (in verifying or reproducing). As described above, if the error correction is incapable or if the number of error-corrected codes exceeds the certain standard value as a result of performing the error correction for the decoded RF signal, the CODEC 355 generates the error signal for indicating that fact, and outputs this signal to the defect detector 359. The defect detector 359 outputs the defect detection signal for indicating the presence of a defect when receiving this error signal.

The DMI generator 360 is a circuit for generating or updating the defect management information 120 on the basis of the defect detection signal outputted from the defect detector 359. The defect management information 120 is rewritably stored into a memory circuit placed in the DMI generator 360. The DMI generator 360 responds to a request command from the backend host 400 and outputs the defect management information 120 to the backend host 400 through the interface 357.

As shown in FIG. 13, the disc drive 300 is equipped with a CPU 361. The CPU 361 controls the disc drive 300 as a whole, and controls the exchange of information (or signal) among the elements in the disc drive 300 described above. The CPU 361 also controls the record operation and the reading operation of the record data and the defect management information 120. The CPU 361 responds to a control command or a request commend transmitted from the backend host 400 and controls the exchange of data between the disc drive 300 and the backend host 400.

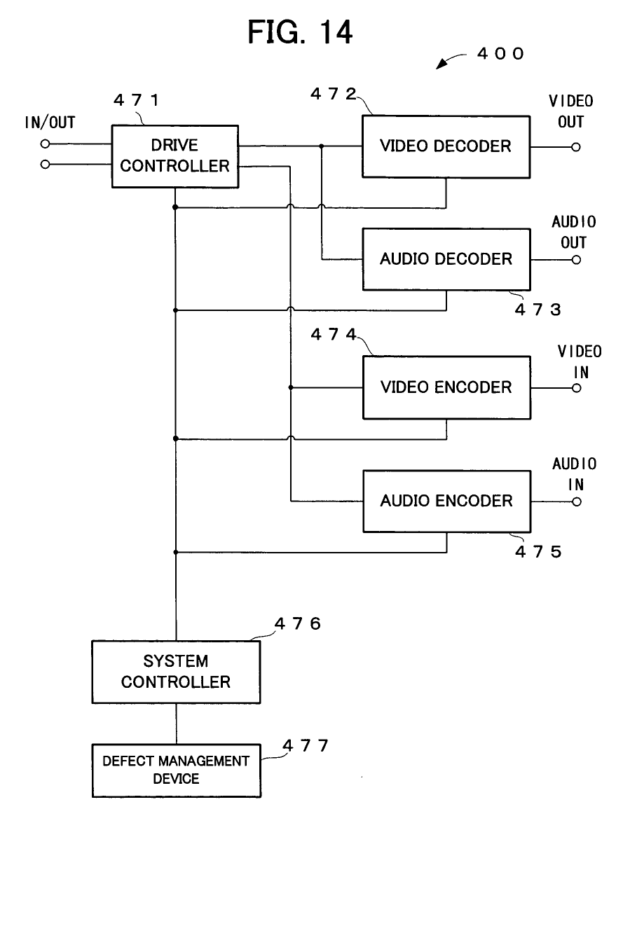

FIG. 14 shows the inner structure of the backend host 400. The backend host 400 is an apparatus for reproducing the record data read from the optical disc 100 with the disc drive 300, receiving the record data supplied from the outside for the purpose to record it onto the optical disc 100, encoding this record data, and transmitting it to the disc drive 300.

The backend host 400 is provided with: a drive controller 471; a video decoder 472; an audio decoder 473; a video encoder 474; an audio encoder 475; a system controller 476; and a defect management device 477.

The drive controller 471 is a circuit for controlling the reading processing and recording processing of the disc drive 300. The backend host 400 and the disc drive 300 cooperate and perform an operation of reading the record data from the optical disc 100 and reproducing it and an operation of receiving the record data from the outside and recording it onto the optical disc 100. The drive controller 471 realizes the cooperation of the backend host 400 and the disc drive 300 by controlling the reading processing and recording processing of the disc drive 300. Specifically, the drive controller 471 outputs to the disc drive 300 request commands about reading, recording, outputting the record data from the buffer 356, outputting the defect management information 120 from the DMI generator 360, and so on. The drive controller 471 also controls the input and output of the record data, the defect management information 120, and other various information.

The video decoder 472 and the audio decoder 473 are circuits for decoding the record data which is read from the optical disc 100 by the disc drive 300 and which is supplied through the drive controller 471 and converting the record data to be reproducible with a display, a speaker, or the like.

The video encoder 474 and the audio encoder 475 are circuit for receiving a video signal, an audio signal, or the like inputted from the outside for the purpose of recording them on the optical disc 100, encoding them by Moving Picture Experts Group (MPEG) compressing and encoding method or the like, and supplying them to the disc drive 300 through the drive controller 471.

In reproducing, the system controller 476 controls: the drive controller 471; the video decoder 472; the audio decoder 473; and the defect management device 477, to thereby reproduce the record data in cooperation with these devices. In recording, the system controller 476 controls: the drive controller 471; the video encoder 474; the audio encoder 475; and the defect management device 477, to thereby record the record data in cooperation with these devices. In reproducing and recording, the system controller 476 controls the disc drive 300 (e.g. controls the generation and transmission of various request commands, the reception of a response signal, or the like) with the drive controller 471 in order to realize the cooperation of the disc drive 300 and the backend host 400.

The defect management device 477 has therein a memory circuit and has a function of receiving and maintaining all or part of the defect management information 120 made or updated by the DMI generator 360 in the disc drive 300. The defect management device 477 performs the defect management with the system controller 476.

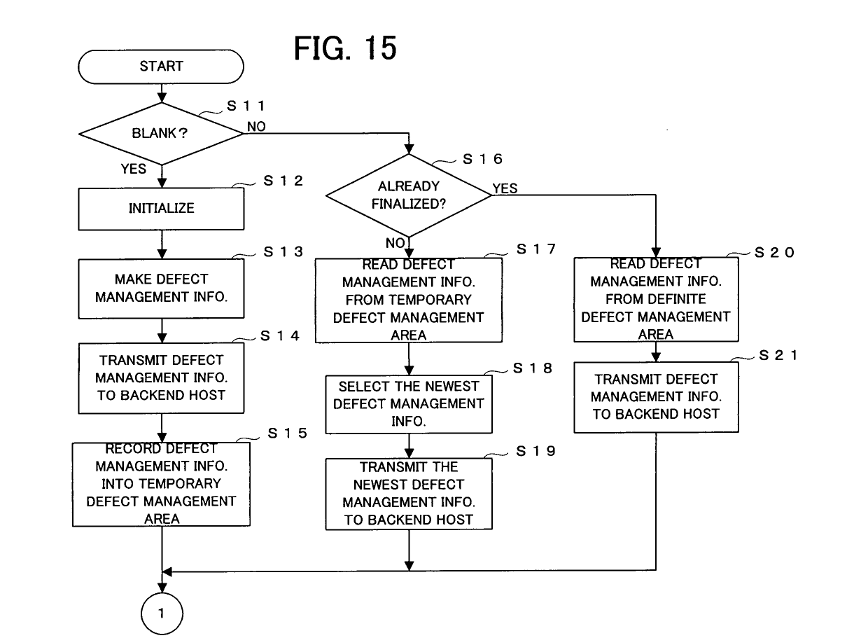

Next, an initial setting operation of the recording/reproducing apparatus 200 will be explained. FIG. 15 shows an initial setting operation of the recording/reproducing apparatus 200. The recording/reproducing apparatus 200 performs the initial setting between (i) when the optical disc 100 is inserted or loaded in the disc drive 300 and (ii) when the record data is recorded or reproduced. The initial setting is processing for preparing for the recording or reproducing of the record data and includes various processing. Out of the processing, the initialization of the optical disc 100, the generation of the defect management information 120, the transmission of the defect management information 120 to the backend host 400, or the like will be explained below. The processing is performed mainly under the control of the CPU 361 of the disc drive 300.

As shown in FIG. 15, when the optical disc 100 is inserted or loaded into the disc drive 300, under the control of the CPU 361 of the disc drive 300, it is judged whether or not the optical disc 100 is an unrecorded disc, i.e., a blank disc (step S11).

If the optical disc 100 is a blank disc (the step S11: YES), under the control of the CPU 361, the optical disc 100 is initialized (step S12). In this initializing, the DMI generator 360 generates the defect management information 120 (step S13). Specifically, it obtains the start address and end address of the user data area 108 and the sizes of the spare areas 109 and 110, which are set in the initializing, and generates the setting information 121. Moreover, it generates the defect list 122. The defect list 122 generated at this time has only an outline, not having any content. Namely, the defect address is not recorded in it, nor is the specific spare address. A head, identification information, or the like are only recorded. The generated defect management information 120 is stored into and maintained in the DMI generator 360.

Then, under the control of the CPU 361, the defect management information 120 stored in the DMI generator 360 is transmitted to the backend host 400 (step S14). The defect management information 120 is stored into the defect management device 477 of the backend host 400.

Then, under the control of the CPU 361, the defect management information 120 stored in the DMI generator 360 is recorded twice repeatedly or redundantly into the temporary defect management area 104 or 105 on the optical disc 100 (step S15). In this case, as described above, the defect management information 120 may be recorded twice repeatedly or redundantly in an unrecorded area.

Particularly, in the embodiment, the defect management information 120 is recorded onto the optical disc 100 by-recording the setting information 121 into one ECC cluster 111 and recording the defect list 122 into another ECC cluster 111.

On the other hand, if the optical disc 100 is not a blank disc (the step S11: NO), under the control of the CPU 361, it is judged whether or not the optical disc 100 is already finalized (step S16). The finalizing is processing for arranging a recording format so that the optical disc 100 can be reproduced by a reproducing apparatus for a general rewritable-type optical disc and a reproducing apparatus for a general optical disc of a reproduce only type (e.g. CD-ROM or DVD-ROM or the like). It is possible to recognize whether or not the optical disc 100 is already finalized by referring to the control information recorded in the lead-in area 101 or the like.

If the optical disc 100 is not finalized yet (the step S16: NO), under the control of the CPU 361, the defect management information 120 is read from the temporary defect management area 104 or 105 on the optical disc 100 (step S17). Namely, if the optical disc 100 is not a blank disc, the defect management information 120 already made in the past is recorded in the temporary defect management area 104 or 105, so that the defect management information 120 is read.

Moreover, if a plurality of defect management information 120 is recorded in the temporary defect management area 104 or 105, under the control of the CPU 361, the newest (effective) defect management information 120 is selected and read among them (step S18). Namely, at a stage before the finalizing, the defect management information 120 is recorded at a proper timing in the temporary defect management area 104 or 105 whenever it is updated. The plurality of defect management information 120 is arranged in series in the updated order. Therefore, the defect management information placed at the end is the newest (effective) defect management information in the temporary defect management area 104 or 105. Under the control of the CPU 361, the defect management information 120 placed at the end is selected and read.

In order to specify the defect management information 120 placed at the end (or the last defect management information 120), the embodiment adopts the following method. Namely, in the case where a plurality of defect management information 120 are already recorded sequentially in a row in the temporary defect management area 104 or 105, some information is recorded from the start address of the temporary defect management area 104 or 105 to the end address of the area in which the last defect management information 120 is recorded, and the subsequent area is unrecorded or blank. The CPU 361 controls the optical pickup 352 to thereby scan the temporary defect management area 104 or 105, starting from the start address. Then, a position from which an unrecorded or blank condition starts is detected, and the temporary defect management area 104 or 105 is scanned backward from the position. This is how to specify the last defect management information 120. By this type of method, it is possible to easily specify the last or latest defect management information 120 (i.e. the effective defect management information 120) without using a pointer or the like.

In addition, since the defect list 122 is divided and recorded on the optical disc 100 associated with the embodiment, the defect list 122 cannot be used properly as the defect management information 120 if the divided defect list 122 is not assembled to its original state.

Then, under the control of the CPU 361, the pointer information 124 included in the setting information 121 or the divided defect list 122 itself (refer to FIG. 10 or FIG. 11) is read, the divided defect list 122 is assembled to its original state according to the read pointer information 124, and it is read as the defect management information 120.

Under the control of the CPU 361, the read effective defect management information 120 is stored into the DMI generator 360, and this effective defect management information 120 is transmitted to the backend host 400 (step S19). The effective defect management information 120 is stored into the defect management device 477 of the backend host 400.

On the other hand, if the optical disc 100 is not a blank disc but is already finalized (the step S16: YES), under the control of the CPU 361, the defect management information 120 is read from the definite defect management area 106 or 107 (step S20), and this information is transmitted to the backend host 400 (step S21). The defect management information 120 is stored into the defect management device 477 of the backend host 400.

As described above, the defect management information 120 is generated, or is selectively read from the temporary defect management area 104 or 105, or is read from the definite defect management area 106 or 107. Then, it is stored into the DMI generator 360 of the disc drive 300 and is stored into the defect management device 477 of the backend host 400. This completes the preparation for the defect management and ends the initial setting.

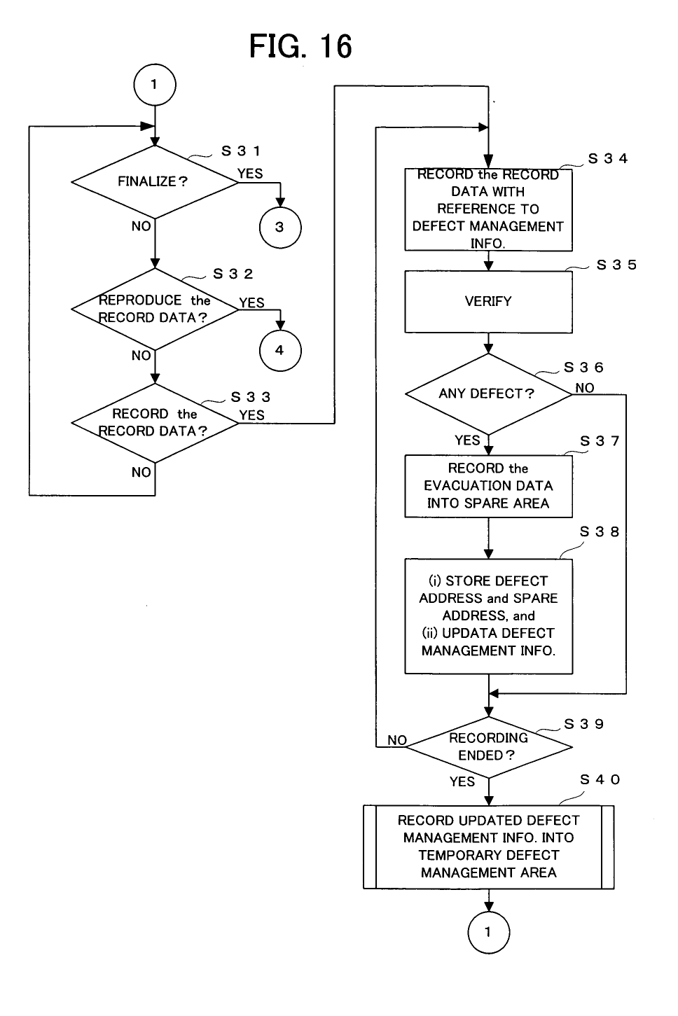

Next, a record operation of the recording/reproducing apparatus 200 will be explained. FIG. 16 mainly shows a record operation of the recording/reproducing apparatus 200. The recording/reproducing apparatus 200 performs a record operation of recording the record data into the user data area 108 on the optical disc 100. The recording/reproducing apparatus 200 performs the record operation while performing the defect management. The recording/reproducing apparatus 200 performs verifying during the record operation and updates the defect list 122 on the basis of the verifying. The record operation is realized by the cooperation of the CPU 361 of the disc drive 300 and the system controller 376 of the backend host 400.

As shown in FIG. 16, after judging whether or not an instruction of finalizing or reproducing the record data from the optical disc 100 is given (steps S31 and S32), when a user inputs an instruction of starting to record (step S33: YES), the recording/reproducing apparatus 200 responds to this and records the record data (step S34). The record data is recorded into each predetermined block. The recording/reproducing apparatus 200 refers to the defect management information stored in the defect management device 477 of the backend host 400 and records the record data while performing the defect management on the basis of the information.

The recording/reproducing apparatus 200 performs verifying at each time of the one block recording or at each time of ending a series of writing sequences (step S35), and updates the defect management information 120 on the basis of the result of the verifying. Incidentally, the defect management information 120 which is updated is the defect management information stored in the DMI generator 360 of the disc drive 300. Specifically, when it is recognized, as a result of the verifying, that the record data fails to be record (step S36: YES), under the control of the CPU 361 of the disc drive 300, the record data that fails to be recorded is recorded into the spare area 109 or 110 (step S37). Then, under the control of the CPU 361, it is estimated that there is a defect in a place in which the record data is supposed to be recorded, and the defect list entry 123, which is a combination of the defect address for indicating the place and the spare address, is recorded as the defect list 122 (step S38).

In this case, under the control of the CPU 361, the defect list entry 123 is recorded as the defect list 122 on which the defect list entries 123 are sorted according to the defect address included in each of the defect list entries 123.

When the above-described steps S34 to S38 end with respect to a series block of the record data to be recorded this time (step S39: Yes), under the control of the CPU 361, the updated defect management information 120 is recorded twice repeatedly or redundantly into the temporary defect management area 104 or 105 on the optical disc 100 (step S40). Incidentally, the defect management information 120 recorded into the temporary defect management area 104 or 105 is the defect management information 120 stored in the DMI generator 360.

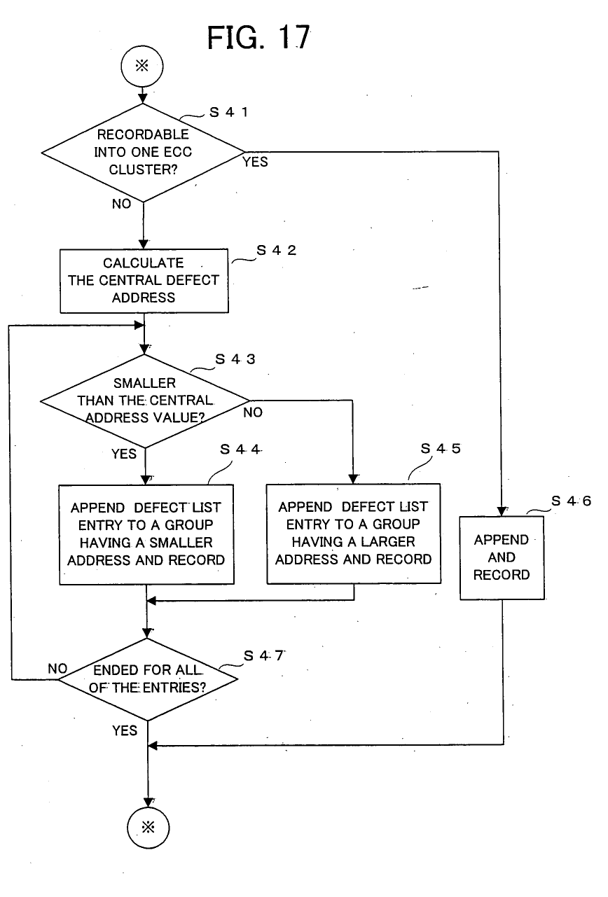

At this time, if the size of the defect list 122 is larger than that of the ECC cluster 111, the defect list 122 is divided and recorded into the temporary defect management area 104 or 105, as described above. Such an operation will be explained with reference to FIG. 17. FIG. 17 shows the detailed record operation for the divided defect list 122.

As shown in FIG. 17, under the control of the CPU 361, it is judged or determined whether or not the defect list 122 (or one portion thereof) can be recorded into one ECC cluster 111 after appending a newly-adding defect list entry 123 onto the defect list 122 (step S41).

As a result of the judgment, if it is judged to be recordable into one ECC cluster 111 (the step S41: Yes), the defect list 122 (or one portion thereof) on which the newly-adding defect list entry 123 is appended is recorded into the one ECC cluster 111 in the temporary defect management area 104 or 105, under the control of the CPU 361 (step S46).

On the other hand, if it is judged not to be recordable into one ECC cluster 111 (the step S41: No), under the control of the CPU 361, the defect addresses included in the defect list entries 123 in the defect list 122 (or one portion thereof) that is judged not to be recordable are referred to. Then, the defect address of the defect list entry 123 existing in the center of the defect list entries 123 in the defect list 122 (or one portion thereof) is calculated or acquired (step S42). Hereinafter, the defect address of the defect list entry 123 existing in the center is referred to as a “central address”, as occasion demands. Incidentally, the “center” in the operation in the step S42 indicates the same meaning as the “center” in FIG. 7.

Then, under the control of the CPU 361, it is compared whether or not the defect address of each of the defect list entries 123 included in the defect list 122 (or one portion thereof) and the defect list entry 123 to be appended, which are judged not to be recordable into one ECC cluster 111 in step S41, is smaller than the central address calculated in the step S42 (step S43).

As a result of the judgment, if it is judged to be smaller than the central address (the step S43: Yes), the defect list entry 123 is included into a group of the defect list entries 123 having a defect address smaller than or equal to the central address out of two divisional lists into which the defect list is divided, and recorded (step S44).

On the other hand, if it is judged to be larger than the central address (the step S43: No), the defect list entry 123 is included into a group of the defect list entries 123 having a defect address larger than the central address out of the two divisional lists into which the defect list is divided, and recorded (step S45).

Then, it is judged whether or not the judgment of inequality is ended with respect to all of the defect list entries 123, which are included in the defect list 122 (or one portion thereof) being judged not to be recordable in step S41 (step S47).

As a result of the judgment, if the judgment of inequality is not ended with respect to all of the defect list entries 123 (the step S47: No), the judgment is performed again in the step S43. On the other hand, if the judgment of inequality is ended with respect to all of the defect list entries 123 (the step S47: Yes), the record operation for the defect list 122 is ended. Incidentally, if a plurality of defect list entries 123 are to be appended in the above processes; namely, if “the step S47: No” is repeated several times, it is unnecessary to perform the recording in the step S44 and the step S45 with respect to actual media. It is also possible to perform the additional processing in the step S44 and the step S45 on a memory of the disc drive 300 or the like and collectively record the defect list entries 123 after “the step S47: No”.

In the record operation after this, only one of the two divisional lists of the defect list 122 is recorded additionally, according to the inequality between the value of the defect address of the defect list entry 123 to be appended and the value of the central address calculated in the step S42. Such an aspect of recording will be described in detail later, with reference to a specific example below (particularly, FIG. 24 to FIG. 26).

Then, the record operation is completed.

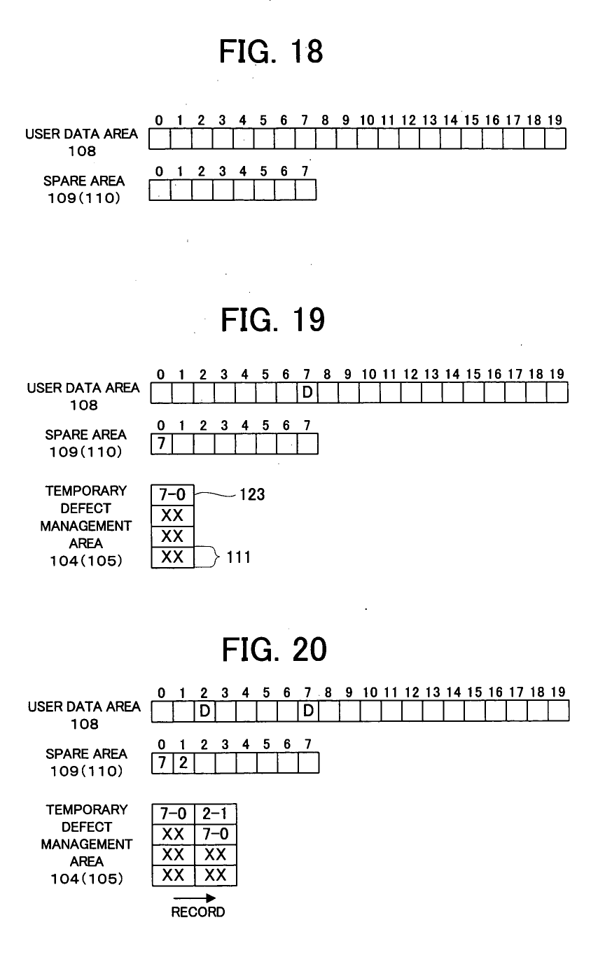

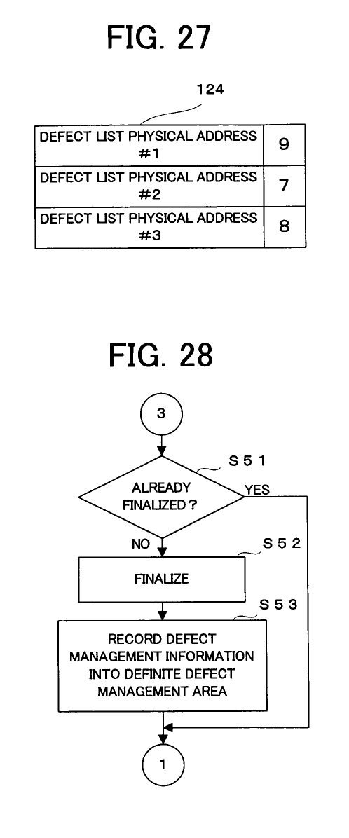

Now, the record operation will be explained in more detail with the illustration of the recording content on the optical disc 100, with reference to FIG. 18 to FIG. 27. FIG. 18 to FIG. 26 conceptually show a process of recording the defect list by the recording/reproducing apparatus 200. FIG. 27 shows the recording content of the pointer information 124 at a time point of ending the process in FIG. 26.

As shown in FIG. 18, it is assumed that the user data area 108 having 20 clusters and the spare area 109 or 110 having 8 clusters are on the optical disc 100. Incidentally, it is also assumed that the address of the user data area 108 is shown with an “address 0” to an “address 19” and that the address of the spare area 109 or 110 is shown with an “address 0” to an “address 7”.

As shown in FIG. 19, it is assumed that a defect is detected in an “address 7” of the user data area 108. Incidentally, “D” in the user data area 108 in FIG. 19 indicates that the defect is detected. At this time, the recording/reproducing apparatus 200 performs the operations in the step S37 to the step S40 in FIG. 16, under the control of the CPU 361. Namely, the recording/reproducing apparatus 200 records, into the “address 0” of the spare area 109 or 110, the record data that is to be recorded into (or already recorded in) the “address 7” of the user data area 108. In addition, the recording/reproducing apparatus 200 records the defect information 120 (i.e. the defect list 122) into the temporary defect management area 104 or 105.

Here, one defect list entry 123 is recorded into one ECC cluster 111. The defect list entry 123 includes a defect address for indicating the “address 7” of the user data area 108 and a spare address for indicating the “address 0” of the spare area 109 or 110. Namely, “7-0” shown in the temporary defect management area 104 or 105 in FIG. 19 indicates that a defect is detected in the “address 7” of the user data are 108 and that the data to be recorded (or already recorded) at that position is recorded in the “address 0” of the spare area 109 or 110.

Then, as shown in FIG. 20, if a new defect is detected in an “address 2” of the user data area 108, the recording/reproducing apparatus 200 records, into an “address 1” of the spare area 109 or 110, the record data that is to be recorded into (or already recorded in) the “address 2” of the user data area 108. Moreover, the recording/reproducing apparatus 200 additionally records a new defect list 122 into which a defect list entry 123 shown by “2-1” is appended, into the temporary defect management area 104 or 105.

In this case, after the defect list entry 123 shown by “2-1” and the defect list entry 123 shown by “7-0” recorded at the step shown in FIG. 19 are sorted according to their defect addresses under the control of the CPU 361 (or the DMI generator 360 under the control of the CPU 361), they are recorded into the temporary defect management area 104 or 105. At this time, the effective defect list 122 on the recording/reproducing apparatus 200 is the newly recorded defect list 122.

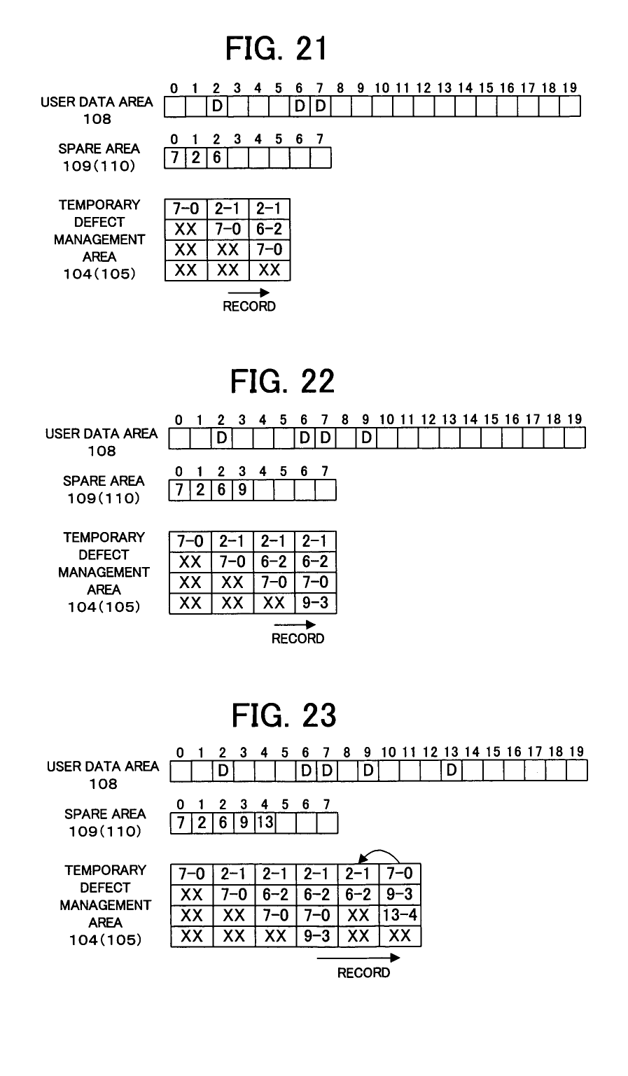

Then, as shown in FIG. 21, if a new defect is detected in an “address 6” of the user data area 108, the recording/reproducing apparatus 200 records, into an “address 2” of the spare area 109 or 110, the record data that is to be recorded into (or already recorded in) the “address 6” of the user data area 108. Moreover, the recording/reproducing apparatus 200 additionally records a new defect list 122 into which a defect list entry 123 shown by “6-2” is appended, into the temporary defect management area 104 or 105.

Moreover, as shown in FIG. 22, if a new defect is detected in an “address 9” of the user data area 108, the recording/reproducing apparatus 200 records, into an “address 3” of the spare area 109 or 110, the record data that is to be recorded into (or already recorded in) the “address 9” of the user data area 108. Moreover, the recording/reproducing apparatus 200 additionally records a new defect list 122 into which a defect list entry 123 shown by “9-3” is appended, into the temporary defect management area 104 or 105.

Then, as shown in FIG. 23, if a new defect is detected in an “address 13” of the user data area 108, the recording/reproducing apparatus 200 records, into an “address 4” of the spare area 109 or 110, the record data that is to be recorded into (or already recorded in) the “address 13” of the user data area 108.

At this time, under the control of the CPU 361, it is judged that a new defect list 122 into which a defect list entry 123 shown by “13-4” is appended has a larger size than that of one ECC cluster 111. Therefore, under the control of the CPU 361, after the defect list 122 is divided, the defect list 122 is recorded by using two ECC clusters 111.

Specifically, the defect addresses of the four defect list entries 123 included in the defect list 122 before appending the new defect list entry 123 shown by “13-4” are compared, and the central address is calculated. In this case, under the control of the CPU 361, it is judged that the central address is the defect address shown by the “address 6” which is the second smallest. Therefore, the defect list 122 is divided into two group: one is a group of the defect list entries 123 shown by “2-1” and “6-2” having a defect address smaller than or equal to the “address 6”; and the other is a group of the defect list entries 123 shown by “7-0” and “9-3” having a defect address larger than the “address 6”. The “address 13”, which is the defect address included in the defect list entry 123 to be appended, is larger than the “address 6” which is the value of the central address, so that it is included in the group of the defect list entries 123 shown by “7-0” and “9-3”. Therefore, under the control of the CPU 361, the defect list 122 is divided as shown in the lower part in FIG. 23, and the divided defect list 122 (i.e. two groups of the defect list entries 123) is recorded.

At the same time, under the control of the CPU 361, the pointer information 124 is newly made, and it is included into the setting information 121 or into one portion of the defect list 122, and it is recorded into the temporary defect management area 104 or 105. After that, the pointer information 124 is newly made and recorded whenever the recording position of the effective defect list 122 (i.e. which reflects the newest defect) in the temporary defect management area 104 or 105 is changed

Then, as shown in FIG. 24, if a new defect is detected in an “address 11” of the user data area 108, the recording/reproducing apparatus 200 records, into an “address 5” of the spare area 109 or 110, the record data that is to be recorded into (or already recorded in) the “address 11” of the user data area 108.

Moreover, the recording/reproducing apparatus 200 additionally records a new defect list 122 (i.e. one divisional list of the defect list 122) into which a defect list entry 123 shown by “11-5” is appended, into the temporary defect management area 104 or 105.

In particular, the “address 11”, which is the defect address of the defect list entry 123 of interest, is larger than the “address 6” which is the central address at the time point in FIG. 23, so that it is included in the group of the defect list entries 123 shown by “7-0”, “9-3”, and “13-4”. Then, nothing is additionally recorded into the group of the defect list entries 123 shown by “2-1” and “6-2”. And the defect list entries 123 additionally recorded at the step shown in FIG. 23 are treated as an effective.

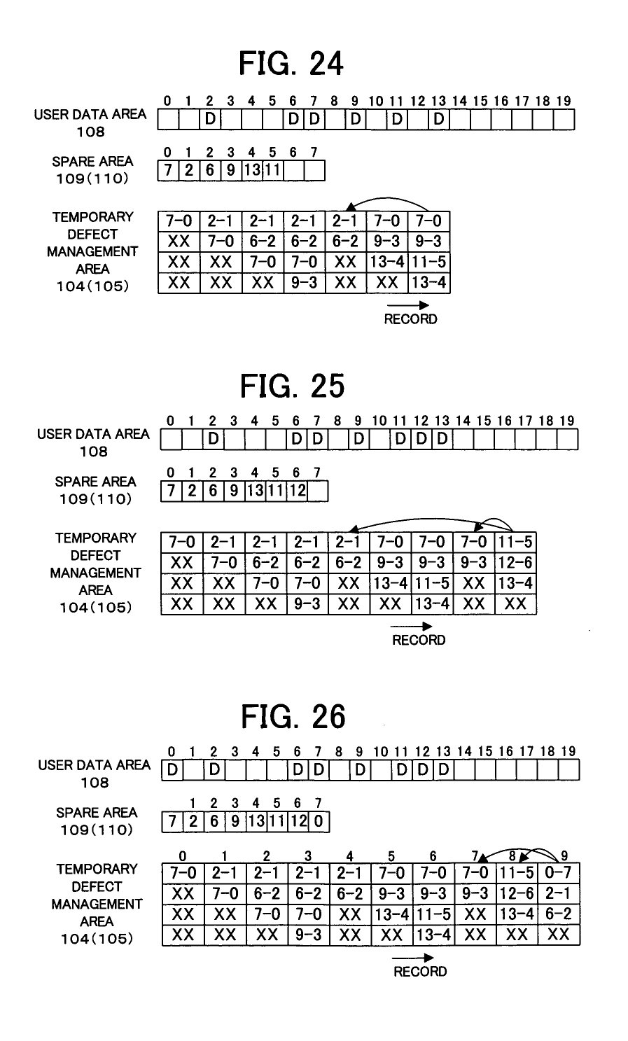

Then, as shown in FIG. 25, if a new defect is detected in an “address 12” of the user data area 108, the recording/reproducing apparatus 200 records, into an “address 6” of the spare area 109 or 110, the record data that is to be recorded into (or already recorded in) the “address 12” of the user data area 108.

Moreover, the recording/reproducing apparatus 200 additionally records a new defect list 122 into which a defect list entry 123 shown by “12-6” is appended, into the temporary defect management area 104 or 105.

At this time, the “address 12”, which is the defect address of the defect list entry 123 to be appended, is larger than the “address 6” which is the central address at the time point in FIG. 23, so that under the control of the CPU 361, it is judged that it is included in the group of the defect list entries 123 shown by “7-0”, “9-3”, “11-5”, and “13-4”.

However, the group of the defect list entries 123 of interest has a larger size than that of one ECC cluster 111, so that the defect list 122 (i.e. divisional list of the defect list 122) is divided again and recorded. In this case, under the control of the CPU 361, it is judged that the central address of the defect addresses of the group of the defect list entries 123 is the “address 9”. Therefore, the defect list 122 is divided into a group of the defect list entries 123 shown by “7-0” and “9-3” having a defect address smaller than or equal to the central address and a group of the defect list entries 123 shown by “11-5” and “13-4” having a defect address larger than the central address, and two groups of the defect list entries 123 are recorded. At the same time, the defect list entry 123 shown by “12-6” is appended into the latter group of the defect list entries 123, and it is recorded.

Then, as shown in FIG. 26, if a new defect is detected in an “address 0” of the user data area 108, the recording/reproducing apparatus 200 records, into an “address 7” of the spare area 109 or 110, the record data that is to be recorded into (or already recorded in) the “address 0” of the user data area 108.

Moreover, the recording/reproducing apparatus 200 additionally records a new defect list 122 into which a defect list entry 123 shown by “0-7” is appended, into the temporary defect management area 104 or 105.

In this case, the “address 0”, which is the defect address of the defect list entry 123 to be appended, is smaller than the “address 6” which is the central address at the time point in FIG. 23, so that it is included in the group of the defect list entries 123 shown by “2-1” and “6-2” to make a new group, and the new group is additionally recorded.

Incidentally, in FIG. 26, the numeral value described on the top of each ECC cluster of the temporary defect management area 104 or 105 shows the address of the ECC cluster 111. The pointer information 124 is made by the CPU 361 by using such an address value, as occasion demands, and recorded.

Now, the pointer information 124 at the time point in FIG. 26 will be explained with reference to FIG. 27. As shown in FIG. 27, the defect list physical address #1 shows the “address 9” out of the temporary defect management area 104 or 105. The defect list physical address #2 shows the “address 7” out of the temporary defect management area 104 or 105. The defect list physical address #3 shows the “address 8” out of the temporary defect management area 104 or 105. Namely, the defect list physical addresses are sorted and recorded in the order of the group of the defect list entries 123 having relatively small defect address, out of the divided defect list 122. By this, the recording/reproducing apparatus 200 is capable of reading the defect list 122 that is relatively easily assembled to its original state from the divided defect list 122 by referring to the pointer information 124.

Then, there is no more free space in the spare area 109 or 110 at the time point in FIG. 26, so that after this, it is impossible to record the record data onto the optical disc 100.

As described above, the recording/reproducing apparatus 200 is capable of performing the defect management appropriately, while dividing and recording the defect list 122, as occasion demands, and using the optical disc 100 (especially the recording capacity of the optical disc 100) efficiently, i.e. reducing a data capacity required for the recording (or additional recording) of the defect management information 120.

Next, the finalizing operation of the recording/reproducing apparatus 200 will be explained. FIG. 28 shows the finalizing operation of the recording/reproducing apparatus 200. For example, when the user inputs an instruction for finalizing (the step S31 in FIG. 16: YES), as shown in FIG. 28, the recording/reproducing apparatus 200 confirms that the optical disc 100 is not finalized yet (step S51: NO) and finalizes the optical disc 100 (step S52). During finalizing, the recording/reproducing apparatus 200 records the defect management information 120 into the definite defect management area 106 or 107 on the optical disc 100 (step S53).

At this time, as described above, the defect management information 120 may be recorded twice repeatedly or redundantly. The recording of the defect management information 120 may be performed once, or three times or more. Incidentally, the defect management information 120 recorded in the definite defect management area 106 or 107 is the defect management information 120 stored in the DMI generator 360. Then, the finalizing operation is completed.

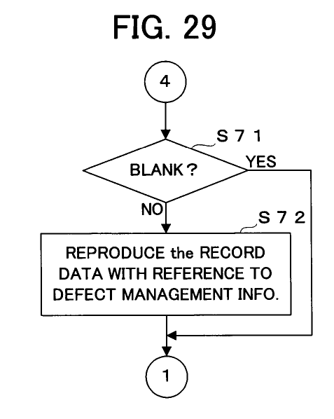

Next, a reproduction operation of the recording/reproducing apparatus 200 will be explained. FIG. 29 shows a reproduction operation of the recording/reproducing apparatus 200.

When the user inputs an instruction of starting to reproduce (the step S32 in FIG. 16: YES), as shown in FIG. 29, the recording/reproducing apparatus 200 confirms that the optical disc 100 is not a blank disc (the step S71: NO), and reproduces the record data recorded in the user data area 108 on the optical disc 100 (step S72). The recording/reproducing apparatus 200 reproduces the record data while performing the defect management on the basis of the defect management information 120 stored in the defect management device 477 of the backend host 400.

Incidentally, the defect management information 120 at this time preferably includes the defect list 122 that is assembled in advance to its original state according to the pointer information 124 by the operation of the recording/reproducing apparatus 200 in the step S17 in FIG. 15. It is also possible to generate and reproduce the appropriate defect list 122 by referring to the pointer information 124, as occasion demands, in reproducing, even if the defect list 122 is stored in the divided condition in the defect management device 477.

As described above, according to the recording/reproducing apparatus 200, it records the defect management information 120 into the temporary defect management area 104 or 105 on the optical disc 100 before finalizing the optical disc 100, and it records the defect management information 120 into the definite defect management area 106 or 107 on the optical disc 100 when finalizing the optical disc 100. With respect to the optical disc 100 which is not finalized yet, the recording/reproducing apparatus 200 reads the defect management information 120 from the temporary defect management area 104 or 105 on the optical disc 100. With respect to the optical disc 100 which is already finalized, the recording/reproducing apparatus 200 reads the defect management information 120 from the definite defect management area 106 or 107 on the optical disc 100. This makes it possible to realize the recording or reproducing of the record data while performing the appropriate defect management with respect to both the optical disc 100 which is not finalized yet and the optical disc 100 which is already finalized.

Particularly, by dividing the defect list 122 as occasion demands and recording it into the temporary defect management area 104 or 105, it is possible to reduce the recording capacity required for the recording (i.e. additional or sequential or postscript recording) of the defect list 122. Therefore, it is possible to avoid the situation that the defect management cannot be performed because of no free space in the temporary defect management area 104 or 105. Namely, the defect management can be performed for a longer time, which possibly increases the lifetime of the optical disc 100.

According to the recording/reproducing apparatus 200 of the present invention, it is constructed such that the defect management information 120 is recorded into the definite defect management area 106 or 107 on the optical disc 100 in finalizing, which allows the compatibility between the write-once-type optical disc 100 and a general rewritable-type optical disc.

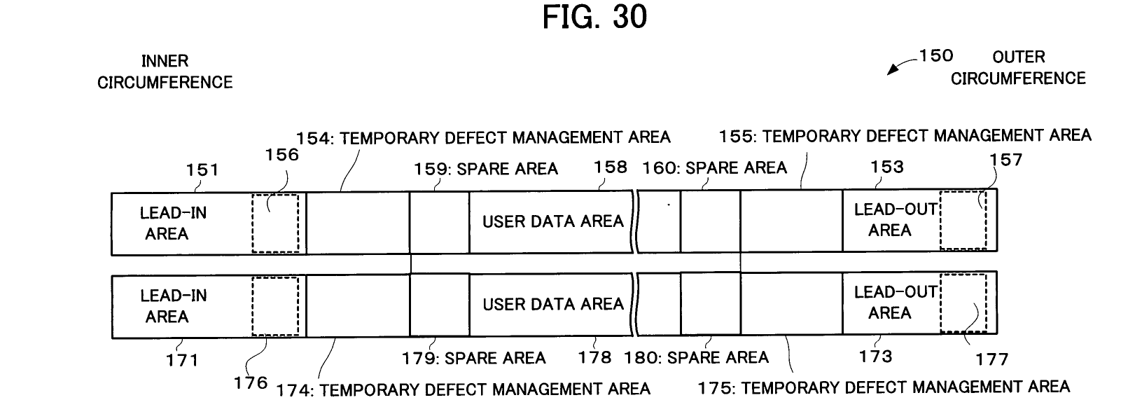

Incidentally, in the above-described embodiment, the case where the information recording medium of the present invention is applied to a one-layer optical disc is given as an example. However, the present invention is not limited to this example and can be applied to a two-or-more-layer optical disc. FIG. 30 shows another embodiment in which the information recording medium of the present invention is applied to a two-layer optical disc. On a first layer of a two-layer optical disc 150 in FIG. 30 (the upper part of FIG. 30), there is a lead-in area 151 on the most inner circumferential side, as with the optical disc 100, and there are a temporary defect management area 154, a spare area 159, a user data area 158, a spare area 160, a temporary defect management area 155, and a lead-out area 153, placed toward the outer circumferential side. And a definite defect management area 156 is disposed in the lead-in area 151 and a definite defect management area 157 is disposed in the lead-out area 153. Even on a second layer, there is a lead-in area 171 on the most inner circumferential side, as with the optical disc 100, and there are a temporary defect management area 174, a spare area 179, a user data area 178, a spare area 180, a temporary defect management area 175, and a lead-out area 173, placed toward the outer circumferential side. And a definite defect management area 176 is disposed in the lead-in area 171 and a definite defect management area 177 is disposed in the lead-out area 173.

Incidentally, in the explanation associated with the two-or-more-layer optical disc in FIG. 30, an example of a parallel track path is shown in which the recording directions of the first layer is the same as that of the second layer. However, the form of an opposite track path in which the recording directions of the first layer is opposite to that of the second layer may be adopted.

Incidentally, the drawings used for the explanation of the embodiments of the present invention embody constitutional elements or the like of the recording medium, recording apparatus or reproducing apparatus of the present invention, only for the purpose of explaining technical ideas thereof. The shape, size, position, connection relationship, and the like of various constitutional elements or the like are not limited to the drawings.

In addition, in the above-described embodiments, the optical disc 100 is explained as one example of the recording medium, and the recorder or the player associated with the optical disc 100 is explained as one example of the recording/reproducing apparatus. The present invention, however, is not limited to the optical disc and the recorder or the player for it. The present invention can be applied to other various information recording media for high density recording or high transfer rate; and a recorder or a player for the media.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-207286 filed on Aug. 12, 2003 including the specification, claims, drawings and summary is incorporated herein by reference in its entirety.

1. An information recording medium comprising:
a data area for recording therein record data; and
a temporary defect management area for temporarily recording therein defect management information which is a basis of defect management for a defect in said data area,
the defect management information being divided into a plurality of divisional defect management information in which one divisional defect management information can be updated independently of another divisional defect management information and being recorded, if the defect management information exceeds a predetermined size.

2. The information recording medium according to claim 1, wherein said temporary defect management area is divided into a plurality of divisional management areas, each having a predetermined size, and at least one of the plurality of divisional defect management information is recorded into at least one of the plurality of divisional management areas.

3. The information recording medium according to claim 1, wherein each of the plurality of divisional defect management information includes a plurality of defect list entries, each of which includes an evacuation source address which is an address of a position of the defect and an evacuation destination address which is an address of a recording position of evacuation data that corresponds to the record data to be recorded or already recorded at the position of the defect.

4. The information recording medium according to claim 3, wherein each of the plurality of defect list entries is included in at least one of the plurality of divisional defect management information, with the plurality of defect list entries sorted according to a value of the evacuation source address owned by each of the plurality defect list entries.

5. The information recording medium according to claim 1, wherein pointer information for indicating a relationship among the plurality of divisional defect management information is further recorded.

6. The information recording medium according to claim 5, wherein the pointer information includes at least one of address values of the plurality of divisional defect management information, with the address values sorted according to the evacuation source address included in the at least one of the plurality of divisional defect management information.

7. The information recording medium according to claim 5, wherein
setting information for indicating a basic structure of said information recording medium is further recorded in said temporary defect management area, and
the pointer information is recorded in the setting information.

8. The information recording medium according to claim 5, wherein the pointer information is recorded in header information owned by the defect management information.

9. The information recording medium according to claim 1, wherein the defect management information is divided into the one divisional defect management information corresponding to one portion of said data area and the another divisional defect management information corresponding to another portion of said data area except the one portion.

10. A recording apparatus for recording record data onto an information recording medium comprising: (i) a data area for recording therein the record data; and (ii) a temporary defect management area for temporarily recording therein defect management information which is a basis of defect management for a defect in said data area,
said recording apparatus comprising:
a first recording device for recording the record data;
a second recording device for recording the defect management information;
a judging device for judging whether or not the defect management information which exceeds a predetermined size is to be recorded by said second recording device; and
a first control device for controlling said second recording device to divide the defect management information into a plurality of divisional defect management information in which one divisional defect management information can be updated independently of another divisional defect management information and to record the defect management information, if it is judged by said judging device that the defect management information which exceeds the predetermined size is to be recorded.

11. The recording apparatus according to claim 10, wherein
the defect management information includes a plurality of defect list entries, each of which includes an evacuation source address which is an address of a position of the defect and an evacuation destination address which is an address of a recording position of evacuation data that corresponds to the record data to be recorded or already recorded at the position of the defect,
said recording apparatus further comprises an obtaining device for obtaining a central address which is the evacuation source address of a defect list entry placed in the center of the defect management information out of the plurality of defect list entries, and
said first control device controls said second recording device to divide the defect management information into a first group which is a group of defect list entries having the evacuation source address larger than the central address and a second group which is a group of defect list entries having the evacuation source address smaller than the central address, as the plurality of divisional defect management information, and to record the defect management information.

12. The recording apparatus according to claim 11, further comprising a second control device for controlling said second recording device, when a new defect list entry is additionally recorded into the divisional defect management information, to append the new defect list entry into the first group and record it if the evacuation address of the new defect list entry is larger than the central address and append the new defect list entry into the second group and record it if the evacuation address of the new defect list entry is smaller than the central address.

13. The recording apparatus according to claim 10, further comprising a third recording device for recording pointer information for indicating a relationship among the plurality of divisional defect management information.

14. A recording method of recording record data onto an information recording medium comprising: (i) a data area for recording therein the record data; and (ii) a temporary defect management area for temporarily recording therein defect management information which is a basis of defect management for a defect in said data area,
said recording method comprising:
a first recording process of recording the record data;
a second recording process of recording the defect management information;
a judging process of judging whether or not the defect management information which exceeds a predetermined size is to be recorded by said second recording process; and
a first control process of controlling said second recording process to divide the defect management information into a plurality of divisional defect management information in which one divisional defect management information can be updated independently of another divisional defect management information and to record the defect management information, if it is judged in said judging process that the defect management information which exceeds the predetermined size is to be recorded.

15. A reproducing apparatus for reproducing record data recorded on an information recording medium comprising: a data area for recording therein the record data; and a temporary defect management area for temporarily recording therein defect management information which is a basis of defect management for a defect in said data area, the defect management information being divided into a plurality of divisional defect management information in which one divisional defect management information can be updated independently of another divisional defect management information and being recorded, if the defect management information exceeds a predetermined size,
said reproducing apparatus comprising:
a first reading device for reading at least one of the plurality of divisional defect management information; and
a reproducing device for reproducing the record data recorded in said data area on the basis of the read at least one divisional defect management information,
said reproducing device reproducing the record data by arranging the at least one divisional defect management information.

16. The reproducing apparatus according to claim 15, further comprising a second reading device for reading pointer information,
said reproducing device arranging the at least one divisional defect management information on the basis of the pointer information.

17. A reproducing method of reproducing record data recorded on an information recording medium comprising: a data area for recording therein the record data; and a temporary defect management area for temporarily recording therein defect management information which is a basis of defect management for a defect in said data area, the defect management information being divided into a plurality of divisional defect management information in which one divisional defect management information can be updated independently of another divisional defect management information and being recorded, if the defect management information exceeds a predetermined size,
said reproducing method comprising:
a first reading process of reading at least one of the plurality of divisional defect management information recorded in said temporary defect management area; and
a reproducing process of reproducing the record data recorded in said data area on the basis of the read at least one divisional defect management information,
said reproducing process reproducing the record databy arranging the at least one divisional defect management information.

18. A computer program product in a computer-readable medium for tangibly embodying a program of instructions executable by a computer to make the computer function as at least one of a first recording device, a second recording device, a judging device, and a first control device,
the computer being provided in a recording apparatus for recording record data onto an information recording medium comprising: (i) a data area for recording therein the record data; and (ii) a temporary defect management area for temporarily recording therein defect management information which is a basis of defect management for a defect in said data area,
said recording apparatus comprising:
said first recording device for recording the record data;
said second recording device for recording the defect management information;
said judging device for judging whether or not the defect management information which exceeds a predetermined size is to be recorded by said second recording device; and
said first control device for controlling said second recording device to divide the defect management information into a plurality of divisional defect management information in which one divisional defect management information can be updated independently of another divisional defect management information and to record the defect management information, if it is judged by said judging device that the defect management information which exceeds the predetermined size is to be recorded.

19. A computer program product in a computer-readable medium for tangibly embodying a program of instructions executable by a computer to make the computer function as at least one of a first reading device and a reproducing device,
the computer being provided in a reproducing apparatus for reproducing record data recorded on an information recording medium comprising: a data area for recording therein the record data; and a temporary defect management area for temporarily recording therein defect management information which is a basis of defect management for a defect in said data area, the defect management information being divided into a plurality of divisional defect management information in which one divisional defect management information can be updated independently of another divisional defect management information and being recorded, if the defect management information exceeds a predetermined size,
said reproducing apparatus comprising:
said first reading device for reading at least one of the plurality of divisional defect management information; and
said reproducing device for reproducing the record data recorded in said data area on the basis of the read at least one divisional defect management information,
said reproducing device reproducing the record data by arranging the at least one divisional defect management information.

20. A data structure comprising:
a data area for recording therein record data; and
a temporary defect management area for temporarily recording therein defect management information which is a basis of defect management for a defect in said data area,
the defect management information being divided into a plurality of divisional defect management information in which one divisional defect management information can be updated independently of another divisional defect management information and being recorded, if the defect management information exceeds a predetermined size.
